(19) United States
(12) Patent Application Publication
(10) Pub. No.: US 2024/0137980 A1
(43) Pub. Date: Apr. 25, 2024

(54) COORDINATED SPATIAL REUSE (C-SR) FRAMEWORK FOR ULTRA-HIGH RELIABILITY (UHR)

(71) Applicant: QUALCOMM Incorporated, San Diego, CA (US)

(72) Inventors: Abdel Karim Ajami, Lakeside, CA (US); Yanjun Sun, San Diego, CA (US); George Cherian, San Diego, CA (US); Alfred Asterjadhi, San Diego, CA (US); Abhishek Pramod Patil, San Diego, CA (US); Sai Yiu Duncan Ho, San Diego, CA (US); Gaurang Naik, San Diego, CA (US)

(21) Appl. No.: 18/049,172

(22) Filed: Oct. 23, 2022

(51) Int. Cl. H04W 74/08; H04B 17/336; H04W 24/10; H04W 72/12

(52) U.S. Cl. CPC H04W 74/0816; H04B 17/336; H04W 24/10; H04W 72/1263

(57) ABSTRACT

This disclosure provides methods, components, devices and systems for coordinated spatial reuse (C-SR) framework for ultra-high reliability (UHR). Some aspects more specifically relate to one or more mechanisms according to which access points (APs) may coordinate with each other in accordance with a C-SR framework. In some implementations, a first access point (AP) may conditionally share a transmission opportunity (TXOP) for the first AP with a second AP in accordance with an interference management procedure between the first AP (and any one or more client devices of the first AP) and the second AP (and any one or more client devices of the second AP). For example, the first AP and the second AP may support one or more frame exchanges associated with an interference measurement and the second AP may share the TXOP if the second AP satisfies a transmit power constraint associated with the interference measurement.

### TECHNICAL FIELD

The following relates to wireless communications, including a coordinated spatial reuse (C-SR) framework for ultra-high reliability (UHR).

### DESCRIPTION OF THE RELATED TECHNOLOGY

Wireless communications systems are widely deployed to provide various types of communication content such as voice, video, packet data, messaging, broadcast, and so on. These systems may be multiple-access systems capable of supporting communication with multiple users by sharing the available system resources (such as time, frequency, and power). A wireless network, for example a WLAN, such as a Wi-Fi (Such as Institute of Electrical and Electronics Engineers (IEEE) 802.11) network may include AP that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via DL and UL. The DL (or forward link) may refer to the communication link from the AP to the station, and the UL (or reverse link) may refer to the communication link from the station to the AP.

### SUMMARY

The systems, methods and devices of this disclosure each have several innovative aspects, no single one of which is solely responsible for the desirable attributes disclosed herein.

One innovative aspect of the subject matter described in this disclosure can be implemented in an apparatus for wireless communication at a first access point (AP). The apparatus includes one or more interfaces and a processing system. The one or more interfaces may be configured to output, to a second AP, an indication of a transmission opportunity (TXOP) for the first AP and information associated with a conditional sharing of the TXOP by the second AP, where the information is associated with an interference measurement between a first communication link and a second communication link, where the first communication link is between the first AP and a first client device of the first AP and the second communication link is between the second AP and a second client device of the second AP. The one or more interfaces may be further configured to output, to the first client device, a message during the TXOP.

Another innovative aspect of the subject matter described in this disclosure can be implemented in a method for wireless communication at a first AP. The method includes transmitting, to a second AP, an indication of a TXOP for the first AP and information associated with a conditional sharing of the TXOP by the second AP, where the information is associated with an interference measurement between a first communication link and a second communication link, where the first communication link is between the first AP and a first client device of the first AP and the second communication link is between the second AP and a second client device of the second AP, and transmitting, to the first client device, a message during the TXOP.

Another innovative aspect of the subject matter described in this disclosure can be implemented in another apparatus for wireless communication at a first AP. The apparatus includes a processor, memory coupled with the processor, and instructions stored in the memory. The instructions may be executable by the processor to cause the apparatus to transmit, to a second AP, an indication of a TXOP for the first AP and information associated with a conditional sharing of the TXOP by the second AP, where the information is associated with an interference measurement between a first communication link and a second communication link, where the first communication link is between the first AP and a first client device of the first AP and the second communication link is between the second AP and a second client device of the second AP and transmit, to the first client device, a message during the TXOP.

Another innovative aspect of the subject matter described in this disclosure can be implemented in another apparatus for wireless communication at a first AP. The apparatus includes means for transmitting, to a second AP, an indication of a TXOP for the first AP and information associated with a conditional sharing of the TXOP by the second AP, where the information is associated with an interference measurement between a first communication link and a second communication link, where the first communication link is between the first AP and a first client device of the first AP and the second communication link is between the second AP and a second client device of the second AP and means for transmitting, to the first client device, a message during the TXOP.

Another innovative aspect of the subject matter described in this disclosure can be implemented in a non-transitory computer-readable medium storing code for wireless communication at a first AP. The code may include instructions executable by a processor to transmit, to a second AP, an indication of a TXOP for the first AP and information associated with a conditional sharing of the TXOP by the second AP, where the information is associated with an interference measurement between a first communication link and a second communication link, where the first communication link is between the first AP and a first client device of the first AP and the second communication link is between the second AP and a second client device of the second AP and transmit, to the first client device, a message during the TXOP.

Another innovative aspect of the subject matter described in this disclosure can be implemented in an apparatus for wireless communication at a second AP. The apparatus includes one or more interfaces and a processing system. The one or more interfaces may be configured to obtain, from a first AP at the second AP, an indication of a TXOP for the first AP and information associated with a conditional sharing of the TXOP by the second AP, where the information is associated with an interference measurement between a first communication link and a second communication link, where the first communication link is between the first AP and a first client device of the first AP and the second communication link is between the second AP and a second client device of the second AP. The one or more interfaces may be further configured to output, to the second client device, a message during the TXOP.

Another innovative aspect of the subject matter described in this disclosure can be implemented in a method for wireless communication at a second AP. The method may include receiving, from a first AP at the second AP, an indication of a TXOP for the first AP and information associated with a conditional sharing of the TXOP by the second AP, where the information is associated with an interference measurement between a first communication link and a second communication link, where the first communication link is between the first AP and a first client device of the first AP and the second communication link is between the second AP and a second client device of the second AP, and transmitting, to the second client device, a message during the TXOP.

Another innovative aspect of the subject matter described in this disclosure can be implemented in another apparatus for wireless communication at a second AP. The apparatus includes a processor, memory coupled with the processor, and instructions stored in the memory. The instructions may be executable by the processor to cause the apparatus to receive, from a first AP at the second AP, an indication of a TXOP for the first AP and information associated with a conditional sharing of the TXOP by the second AP, where the information is associated with an interference measurement between a first communication link and a second communication link, where the first communication link is between the first AP and a first client device of the first AP and the second communication link is between the second AP and a second client device of the second AP and transmit, to the second client device, a message during the TXOP.

Another innovative aspect of the subject matter described in this disclosure can be implemented in another apparatus for wireless communication at a second AP. The apparatus may include means for receiving, from a first AP at the second AP, an indication of a TXOP for the first AP and information associated with a conditional sharing of the TXOP by the second AP, where the information is associated with an interference measurement between a first communication link and a second communication link, where the first communication link is between the first AP and a first client device of the first AP and the second communication link is between the second AP and a second client device of the second AP and means for transmitting, to the second client device, a message during the TXOP.

Another innovative aspect of the subject matter described in this disclosure can be implemented in a non-transitory computer-readable medium storing code for wireless communication at a second AP. The code may include instructions executable by a processor to receive, from a first AP at the second AP, an indication of a TXOP for the first AP and information associated with a conditional sharing of the TXOP by the second AP, where the information is associated with an interference measurement between a first communication link and a second communication link, where the first communication link is between the first AP and a first client device of the first AP and the second communication link is between the second AP and a second client device of the second AP and transmit, to the second client device, a message during the TXOP.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network that supports a coordinated spatial reuse (C-SR) framework for ultra-high reliability (UHR).

FIG. 2 shows an example signaling diagram that supports a C-SR framework for UHR.

FIG. 3 shows example frame transmission schedules that support a C-SR framework for UHR.

FIGS. 4-7 show example communication timelines that support a C-SR framework for UHR.

FIG. 8 shows example frame exchanges that support a C-SR framework for UHR.

FIG. 9 shows example frame alignments that support a C-SR framework for UHR.

FIGS. 10 and 11 show flowcharts illustrating example processes performable by a wireless AP that supports a C-SR framework for UHR.

FIG. 12 shows a block diagram of an example wireless communication device that supports a C-SR framework for UHR.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (JOT) network.

Various aspects relate generally to supporting one or more signaling- or configuration-based mechanisms according to which access points (APs) may coordinate with each other, such as in accordance with a coordinated spatial reuse (C-SR) framework, on various communication aspects. Some aspects more specifically relate to how a first AP may conditionally share a transmission opportunity (TXOP) for the first AP with a second AP in accordance with an interference management procedure between the first AP (and any one or more client devices of the first AP) and the second AP (and any one or more client devices of the second AP). In some implementations, the first AP and the second AP may perform an interference measurement procedure (which may include exchanging one or more frames, triggering a transmission of one or more frames from client devices of the first AP or the second AP, or any combination thereof). The first AP or the second AP, or both, may receive an indication of, measure, or otherwise ascertain information associated with interference between communication involving the first AP and communication involving the second AP.

Accordingly, in scenarios in which the first AP obtains a TXOP, the first AP may conditionally share the TXOP with the second AP in accordance with the information associated with the interference between the first AP and the second AP. In some implementations, the first AP may transmit information associated with the conditional sharing to the second AP, where the information may indicate an upper limit transmit power that the second AP may use for downlink communication or configure for uplink communication during a portion of the TXOP allocated to the second AP. Depending on a format of the interference measurement procedure, the information that the first AP transmits to the second AP may include an explicit indication of the upper limit transmit power or may include an indication of one or more parameters from which the second AP may determine, calculate, compute or select the upper limit transmit power. As such, the second AP may share the TXOP with the first AP (such that both the first AP and the second AP may transmit or receive concurrently) if the second AP is able to use or configure a transmit power that is less than or equal to the upper limit transmit power.

Particular aspects of the subject matter described in this disclosure can be implemented to realize one or more of the following potential advantages. In some implementations, by supporting a C-SR framework that is conditioned in accordance with an interference measurement between communication involving the first AP and communication involving the second AP, the described techniques can be used to enhance coordination among APs in time and frequency to achieve greater reliability, such as ultra-high reliability (UHR), of the network in terms of latency, throughput, and channel access fairness. For example, in accordance with the described interference-based conditional TXOP sharing, the first AP may provide the second AP with more opportunities for communication between the second AP and one or more client devices of the second AP without compromising an integrity or reliability of a principal transmission between the first AP and a client device of the first AP. As such, the first AP and the second AP may achieve lower or more predictable latency (or both lower and more predictable latency), higher data rates, greater spectral efficiency, and greater system capacity, among other benefits.

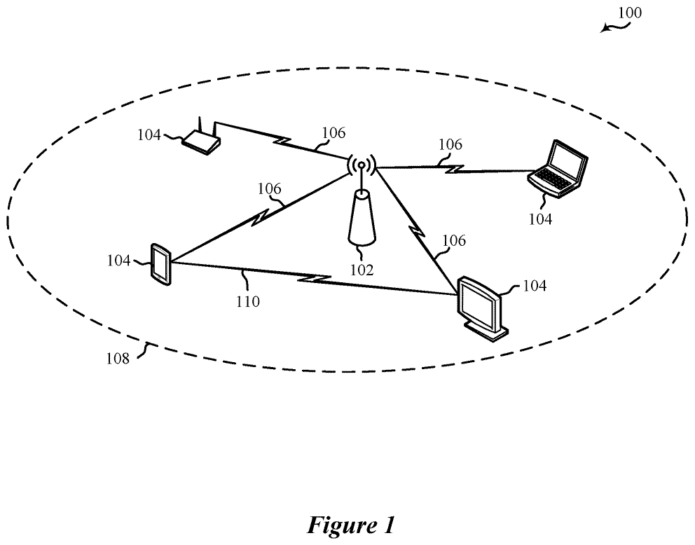

FIG. 1 shows a pictorial diagram of an example wireless communication network 100 that supports a C-SR framework for UHR. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az, 802.11ba, 802.11bd, 802.11be, 802.11bf, and the 802.11 amendment associated with Wi-Fi 8). The WLAN 100 may include numerous wireless communication devices such as a wireless AP 102 and multiple wireless STAs 104. While only one AP 102 is shown in FIG. 1, the WLAN 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE or 5G NR can be further improved by a small cell which is supported by an AP serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (such as TVs (including smart TVs), computer monitors, navigation systems, among others), music or other audio or stereo devices, remote control devices (“remotes”), printers, kitchen appliances (including smart refrigerators) or other household appliances, key fobs (such as for passive keyless entry and start (PKES) systems), Internet of Things (IoT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some implementations, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some implementations, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some examples of the APs 102 and STAs 104 described herein also may communicate in other frequency bands, such as the 5.9 GHz and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium at the particular time. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some implementations, the wireless communication device may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is then compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a TXOP and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

Some APs 102 and STAs 104 may implement spatial reuse techniques. For example, APs 102 and STAs 104 configured for communications using IEEE 802.11ax or 802.11be may be configured with a BSS color. APs 102 associated with different BSS s may be associated with different BSS colors. A BSS color is a numerical identifier of an AP's respective BSS (such as a 6 bit field carried by the SIG field). Each STA 104 may learn its own BSS color upon association with the respective AP. BSS color information is communicated at both the PHY and MAC sublayers. If an AP 102 or a STA 104 detects, obtains, selects, or identifies, a wireless packet from another wireless communication device while contending for access, the AP 102 or STA 104 may apply different contention parameters in accordance with whether the wireless packet is transmitted by, or transmitted to, another wireless communication device within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA, the AP 102 or STA 104 may use a first received signal strength indication (RSSI) detection threshold when performing a CCA on the wireless channel. However, if the BSS color associated with the wireless packet is different than the BSS color of the AP 102 or STA, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs 102 and STAs 104 may implement techniques for spatial reuse that involve participation in a coordinated communication scheme. According to such techniques, an AP 102 may contend for access to a wireless medium to obtain control of the medium for a TXOP. The AP 102 that wins the contention (hereinafter also referred to as a “sharing AP”) may select one or more other APs 102 (hereinafter also referred to as “shared APs 102”) to share resources of the TXOP. The sharing and shared APs 102 may be located in proximity to one another such that at least some of their wireless coverage areas at least partially overlap. Some examples may specifically involve coordinated AP 102 TDMA or OFDMA techniques for sharing the time or frequency resources of a TXOP. To share its time or frequency resources, the sharing AP 102 may partition the TXOP into multiple time segments or frequency segments each including respective time or frequency resources representing a portion of the TXOP, The sharing AP 102 may allocate the time or frequency segments to itself or to one or more of the shared APs 102. For example, each shared AP 102 may utilize a partial TXOP assigned by the sharing AP 102 for its uplink or downlink communications with its associated STAs 104.

In some examples of such TDMA techniques, each portion of a plurality of portions of the TXOP includes a set of time resources that do not overlap with any time resources of any other portion of the plurality of portions. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some other examples of OFDMA techniques, each portion of the plurality of portions of the TXOP includes a set of frequency resources that do not overlap with any frequency resources of any other portion of the plurality of portions. In such implementations, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units (RUs) associated with each portion of the TXOP such as for multi-user OFDMA.

In this manner, the sharing AP's acquisition of the TXOP enables communication between one or more additional shared APs 102 and their respective BSSs, subject to appropriate power control and link adaptation. For example, the sharing AP 102 may limit the transmit powers of the selected shared APs 102 such that interference from the selected APs 102 does not prevent STAs 104 associated with the TXOP owner from successfully decoding packets transmitted by the sharing AP. Such techniques may be used to reduce latency because the other APs 102 may not need to wait to win contention for a TXOP to be able to transmit and receive data according to conventional CSMA/CA or EDCA techniques. Additionally, by enabling a group of APs 102 associated with different BSSs to participate in a coordinated AP 102 transmission session, during which the group of APs 102 may share at least a portion of a single TXOP obtained by any one of the participating APs 102, such techniques may increase throughput across the BSSs associated with the participating APs 102 and also may achieve improvements in throughput fairness. Furthermore, with appropriate selection of the shared APs 102 and the scheduling of their respective time or frequency resources, medium utilization may be maximized or otherwise increased while packet loss resulting from OBSS interference is minimized or otherwise reduced. Various implementations may achieve these and other advantages without requiring that the sharing AP 102 or the shared APs 102 be aware of the STAs 104 associated with other BSSs, without requiring a preassigned or dedicated master AP 102 or preassigned groups of APs 102, and without requiring backhaul coordination between the APs 102 participating in the TXOP.

In some examples in which the signal strengths or levels of interference associated with the selected APs 102 are relatively low (such as less than a given value), or when the decoding error rates of the selected APs 102 are relatively low (such as less than a threshold), the start times of the communications among the different BSSs may be synchronous. Conversely, when the signal strengths or levels of interference associated with the selected APs 102 are relatively high (such as greater than the given value), or when the decoding error rates of the selected APs 102 are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP 102 (or its associated STAs 104) to decode the preamble of the wireless packet and obtain the BSS color value carried in the wireless packet to determine whether the wireless packet is an intra-BSS packet or an OBSS packet. In this manner, each of the participating APs 102 and their associated STAs 104 may be able to receive and decode intra-BSS packets in the presence of OBSS interference.

In some implementations, the sharing AP 102 may perform polling of a set of un-managed or non-co-managed APs 102 that support coordinated reuse to identify candidates for future spatial reuse opportunities. For example, the sharing AP 102 may transmit one or more spatial reuse poll frames as part of determining one or more spatial reuse criteria and selecting one or more other APs 102 to be shared APs 102. According to the polling, the sharing AP 102 may receive responses from one or more of the polled APs 102. In some specific examples, the sharing AP 102 may transmit a coordinated AP TXOP indication (CTI) frame to other APs 102 that indicates time and frequency of resources of the TXOP that can be shared. The sharing AP 102 may select one or more candidate APs 102 upon receiving a coordinated AP 102 TXOP request (CTR) frame from a respective candidate AP 102 that indicates a desire by the respective AP 102 to participate in the TXOP. The poll responses or CTR frames may include a power indication, for example, an RX power or RSSI measured by the respective AP. In some other examples, the sharing AP 102 may directly measure potential interference of a service supported (such as UL transmission) at one or more APs 102, and select the shared APs 102 based on the measured potential interference. The sharing AP 102 generally selects the APs 102 to participate in coordinated spatial reuse such that it still protects its own transmissions (which may be referred to as primary transmissions) to and from the STAs 104 in its BSS. The selected APs 102 may then be allocated resources during the TXOP as described above.

In some systems or networks, APs 102 may lack mechanisms according to which the APs 102 are able to support coordination among APs 102. For example, some network specifications may lack a supported signaling mechanism according to which APs 102 may efficiently coordinate or share communication resources (such as time or frequency resources), such as in accordance with a C-SR framework. In some aspects, such a lack of support for coordination among APs 102 may result in a low adoption rate of C-SR in Wi-Fi systems, which may be associated with or otherwise result in relatively high latency, relatively low throughput, and relatively frequent or high levels of channel access unfairness (such as relatively greater channel access disparities among APs 102, which may be associated with a lack of fairness in terms of transmission opportunities) as compared to systems that more effectively leverage C-SR.

In some implementations, APs 102 may support a C-SR framework for high-reliability communication, such as UHR communication, according to which the APs 102 may employ one or more signaling mechanisms that enable the APs 102 to account for one or more C-SR considerations. For example, in accordance with the techniques described herein, APs 102 may control interference from overlapping BSS (OBSS) transmissions with schemes for one or both of principal transmission protection or total throughput gain. Some specific aspects relate to how APs 102 may measure, collect, receive, or otherwise ascertain link measurement information for controlling interference and preventing control frame wipe out (such as Trigger frame or block acknowledgement (BA) failure) and false-locking (which may refer to how a STA 104 locks to a PPDU from an OBSS and fails to decode a PPDU within a BSS).

Accordingly, a first AP 102 may obtain a TXOP for the first AP 102 and, in some implementations, may share the TXOP with a second AP 102 in accordance with the one or more C-SR considerations. Such C-SR considerations may include scenarios in which C-SR is used with coordinated TDMA (C-TDMA), coordinated target wake time (TWT), or other potential coordinated AP transmissions. In some aspects, coordinated TWT may include or be associated with Coordinated Individual or Broadcast or Restricted or Off-channel TWT, or any combination thereof. Off-channel TWT may allow a STA 104 to negotiate with its AP TWT schedules on a channel where the AP does not operate. The first AP 102 may be referred to as a TXOP-sharing AP 102 or a TXOP owner, and the second AP 102 may be referred to as a TXOP-shared AP (as the second AP 102 is an AP to which at least part of the TXOP for the first AP 102 is shared). The first AP 102 and the second AP 102 may be in range of each other to facilitate over-the-air (OTA) signaling mechanisms between the first AP 102 and the second AP 102. Further, the first AP 102 and the second AP 102 may support backhaul coordination, but may support the described techniques in accordance with an expectation of a lack of backhaul coordination. In scenarios in which the first AP 102 and the second AP 102 support backhaul coordination, the first AP 102 and the second AP 102 may exchange backhaul signaling to avoid some OTA signaling. In some aspects, two TXOP-shared APs 102 (such as the second AP 102 and a third AP 102 to which the TXOP for the first AP 102 is also shared) may or may not be in range of each other. Further, any AP 102 may become a TXOP-sharing AP 102 when the AP 102 wins or otherwise obtains a TXOP (such that there may be no pre-assigned Master AP 102 or pre-assigned AP groups).

In some implementations, the first AP 102 may share or grant a TXOP with or to the second AP 102 and the second AP 102 may become the TXOP owner. In other words, the second AP 102 may acquire the TXOP (or may otherwise effectively become the TXOP owner) in accordance with being granted or shared resources of the TXOP by the first AP 102. In such implementations, the second AP 102 may share resources of the TXOP with one or more other APs 102. The one or more other APs 102 with which the second AP 102 shares the TXOP may or may not be in range of the first AP 102. In some aspects, the one or more other APs 102 may include the first AP 102. As such, in a coordinated individual/broadcast/restricted target wake time (TWT) scenario, the first AP 102 and the second AP 102 may exchange (such as transmit or receive, or both) signaling to negotiate one or more C-SR parameters in the event that coordinated TWT service periods (SPs) overlap, where such an overlap may be a full overlap or a partial overlap.

In some aspects, the first AP 102 (the TXOP-sharing AP 102) and the second AP 102 (the TXOP-shared AP 102) may use the same or different bandwidths and may use the same or different primary channels, or both. In implementations in which the first AP 102 and the second AP 102 use different primary channels, a TXOP sharing protocol may account for the differences in primary channel (as long as the primary channel of the second AP 102 falls within a BSS bandwidth of the first AP 102). In some implementations, C-SR signaling and grant frames (and any other frames associated with coordination between the first AP 102 and the second AP 102) exchanged between the first AP 102 and the second AP 102 may be transmitted on an overlapping portion of the coordinating APs 102 bandwidth. For example, the first AP 102 may be associated with a first BSS bandwidth and the second AP 102 may be associated with a second BSS bandwidth that at least partially overlaps with the first BSS bandwidth. As such, the first AP 102 may transmit information associated with a conditional sharing of the TXOP for the first AP 102 in a duplicate format (such as duplicated across multiple different frequencies) to enable the second AP 102 to receive the information via the overlapping portion between the first BSS bandwidth and the second BSS bandwidth. In other words, C-SR signaling and grant frames may be transmitted in a non-HT duplicate format in at least the overlapping portion of the bandwidths of the coordinating APs 102. Such C-SR signaling and grant frames may differ from other frames, such as beacon frames, that are transmitted exclusively via a primary channel (which may or may not overlap with an operating bandwidth of another AP).

The first AP 102 may use one or more of various frame types for the transmission of the C-SR grant, measurement signaling, or other signaling associated with conditional TXOP sharing. In some implementations, the first AP 102 may include the C-SR grant in a control frame that is exclusively used for conveying C-SR grants associated with conditional TXOP sharing. Such a control frame may be a Trigger frame, a multi-user (MU) request-to-send (RTS) TXOP sharing (TXS) Trigger frame, or a TXS Trigger frame variant, which may be referred to herein as a TXS' frame. In some aspects, a triggered TXOP sharing mode may be exclusively or dedicatedly defined for C-SR. In some aspects, a same TXS' frame may include both a C-TDMA allocation and a C-SR allocation. In such aspects, the triggered TXOP sharing mode may not be dedicated for C-SR and may include additional coordinated AP resources (such as C-TDMA resources).

The first AP 102 and the second AP 102 may each communicate with one or more respective client devices, which may be STAs 104, and a client of the second AP 102 (the TXOP-shared AP 102) may or may not be in range of the first AP 102 (the TXOP-sharing AP 102). Further, the wireless communications network may support scheduling of pre-UHR (such as extremely high throughput (EHT) or high efficiency (HE)) STAs without changes to a pre-UHR feature set. In some aspects, the first AP 102 may share the TXOP for the first AP 102 such that a quantity of reuse transmissions is equal to one at a given time, which may facilitate network simplicity and relatively lower complexity. In some other aspects, the first AP 102 may share the TXOP for the first AP 102 such that a quantity of reuse transmissions is equal to two or more at a given time, which may facilitate greater throughput and system capacity.

In some implementations, the first AP 102 and the second AP 102 may expect or support a relatively small amount of OTA information exchanges between the first AP 102 and the second AP 102 (such as minimal OTA information exchanges between APs 102) and may support a configuration or expectation that interference measurements of STAs 104 within each BSS will not be shared with other BSSs. In some aspects, the first AP 102 may limit C-SR TXOPs to downlink-downlink or to uplink-uplink coordination. In other words, the first AP 102 may share the TXOP for the first AP 102 with the second AP 102 such that the first AP 102 and the second AP 102 either concurrently transmit downlink messaging or concurrently transmit uplink messaging. For example, TXOP sharing may be associated with an expectation that all APs 102 are primarily performing uplink transmissions or are primarily performing downlink transmissions during the shared TXOP, although per-PPDU level alignment may or may not be expected.

Further, as described herein, a principal transmission may refer to a transmission of between the first AP 102 (the TXOP-sharing AP 102) and a client device of the first AP 102, such as a transmission in the TXOP owner BSS. Similarly, a TXOP-sharing AP 102 (such as a TXOP owner) may be referred to as a principal AP 102 in accordance with performing, scheduling, or triggering the principal transmission. In other words, an AP 102 that obtains the TXOP and shares the TXOP with other AP may be referred to as a principal AP 102. A reuse transmission may refer to a transmission between the second AP 102 (the TXOP-shared AP 102) and a client device of the second AP 102, such as a transmission, as allowed by C-SR, in the TXOP shared BSS. For example, the second AP 102 may “reuse” the TXOP for the first AP 102 to perform a reuse transmission. In some aspects, a principal transmission may be associated with a relatively higher priority than a reuse transmission and, in some implementations, the first AP and the second AP may coordinate TXOP sharing to protect the principal transmission from interference arising from the reuse transmission. In some other aspects, a principal transmission and a reuse transmission may be associated with a same priority. In such aspects, the first AP 102 and the second AP 102 may coordinate or negotiate TXOP sharing to enable simultaneous communication of both the principal transmission and the reuse transmission (such as to increase a total system throughput).

Further, although described in the context of conditional (and potentially negotiated) TXOP sharing between two APs 102, the described techniques may be applied for conditional (and potentially negotiated) TXOP sharing between various device types or functionalities. In some implementations, for example, a TXOP sharing AP 102 may share the TXOP with a STA 104 for concurrent transmissions involving the AP 102 and the STA 104. In such implementations, the TXOP sharing AP 102 may receive an uplink transmission or perform a downlink transmission and the STA 104 may simultaneously initiate a peer-to-peer (P2P) transmission with a peer STA 104 where the interference can be manageable.

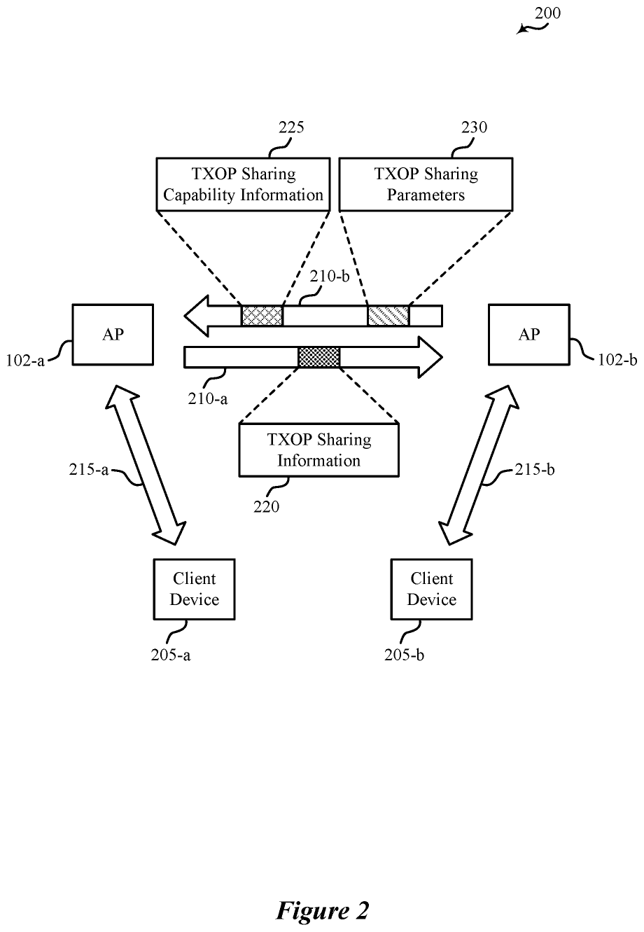

FIG. 2 shows an example signaling diagram 200 that supports C-SR framework for UHR. The signaling diagram 200 may implement or be implemented to realize or facilitate aspects of the WLAN 100. For example, the signaling diagram 200 illustrates communication and coordination between an AP 102-a and an AP 102-b. The AP 102-a may be an example of an AP 102, such as the first AP 102 or a TXOP-sharing AP 102, as described with reference to FIG. 1. The AP 102-b may be an example of an AP 102, such as the second AP 102 or a TXOP-shared AP 102, as described with reference to FIG. 1. In some implementations, the AP 102-a and the AP 102-b may support a signaling mechanism according to which the AP 102-a may conditionally share a TXOP for the AP 102-a with the AP 102-b in accordance with an interference measurement involving communication to or from the AP 102-a and communication to or from the AP 102-b.

As illustrated by the signaling diagram 200, the AP 102-a may transmit signaling to the AP 102-b via a communication link 210-a and the AP 102-b may transmit signaling to the AP 102-a via a communication link 210-b. In some aspects, communication between the AP 102-a and the AP 102-b via the communication link 210-a and the communication link 210-b may include one or both of OTA signaling or backhaul signaling. The AP 102-a may communicate with a client device 205-a of the AP 102-a via a communication link 215-a and the AP 102-b may communicate with a client device 205-b of the AP 102-b via a communication link 215-b. Further, the AP 102-a and the AP 102-b may be associated with various device types that are capable of functioning or operating as an AP. In some deployments, for example, one or both of the AP 102-a or the AP 102-b may be a Mobile AP (such as a Soft AP). For example, the AP 102-a or the AP 102-b may be a phone acting or functioning as a Mobile AP.

In some scenarios, the AP 102-a may obtain a TXOP for the AP 102-a, which the AP 102-a may obtain in accordance with a channel access procedure. In some implementations, the AP 102-a may support an interference management or measurement procedure according to which the AP 102-a may conditionally share the TXOP for the AP 102-a with one or more other APs 102 (such as the AP 102-b) without compromising or adversely impacting a principal transmission between the AP 102-a and the client device 205-a. The interference management or measurement procedure may include one or more frame exchanges between one or more of the AP 102-a, the AP 102-b, the client device 205-a, or the client device 205-b.

The AP 102-a and the AP 102-b may support one or more interference measurement designs. In some aspects, which design the AP 102-a and the AP 102-b support may be associated with or depend on a capability or classification of one or more of the AP 102-a, the AP 102-b, the client device 205-a, or the client device 205-b. For example, the AP 102-a and the AP 102-b may support a UHR frame-based interference measurement or a non-UHR frame-based interference measurement. Such a non-UHR frame-based interference measurement may be referred to herein as a legacy frame-based interference measurement, which may include an 802.11be, 802.11ax, 802.11ac, etc., frame-based interference measurement.

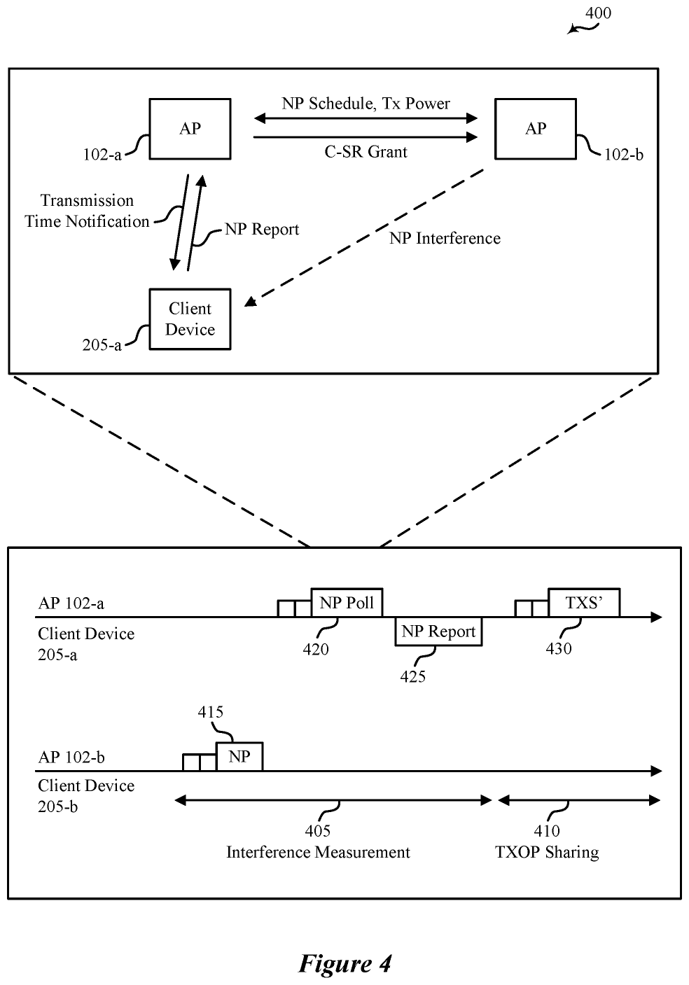

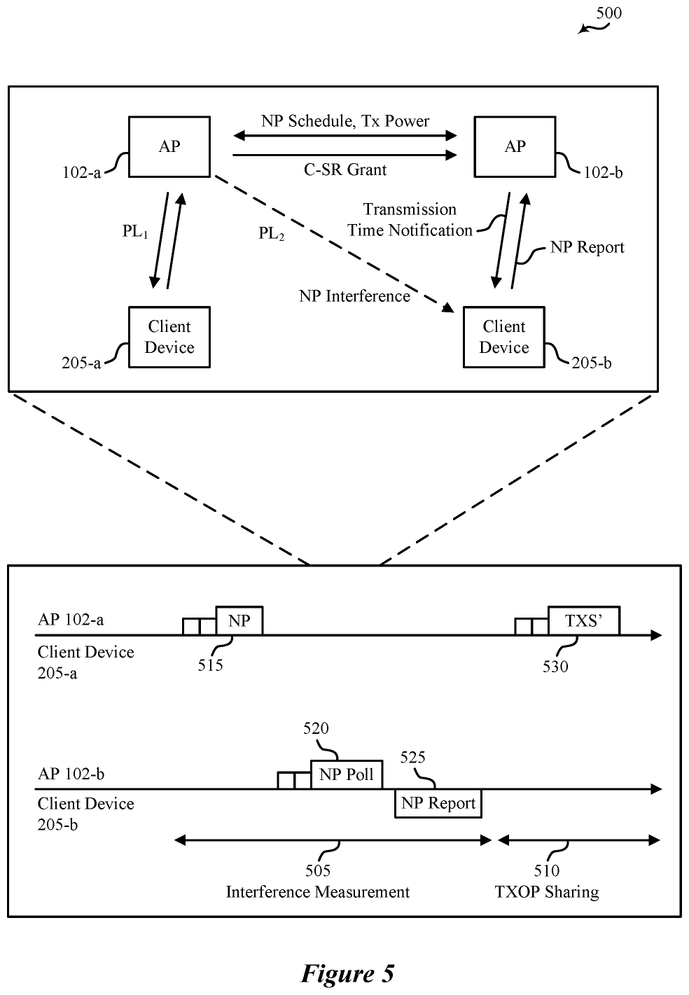

In accordance with a UHR-based measurement design (such as a UHR-based measurement principal), each of the AP 102-a and the AP 102-b (UHR APs 102) may transmit a measurement frame and the client device 205-a and the client device 205-b (UHR clients) from the neighboring AP(s) 102 may measure the measurement frames and report the measurement to an associated AP 102. In some aspects, the AP 102-a or the AP 102-b, or both, may transmit measurement frames at regular (such as fixed or configured) times and the client device 205-a and the client device 205-b may perform measurements in the background. As described herein, background measurements may occur at any time. For example, the client device 205-a and the client device 205-b may perform background measurements in the same TXOP. In accordance with the UHR-based measurement procedure, each of the AP 102-a and the AP 102-b (UHR APs 102) may receive an indication of, learn, or otherwise determine a pathloss for each of its clients with respect to each of the neighboring APs 102 and information used to control a reuse transmission power to protect a principal transmission power. In some aspects, such a UHR-based measurement procedure may be associated with finer C-SR power control and background measurements (such as measurements that are not at TXOP level) and may be employed by UHR-capable devices. Additional aspects relating to interference management or measurement procedures associated with a UHR-based measurement design are illustrated by and described with reference to FIGS. 4 and 5.

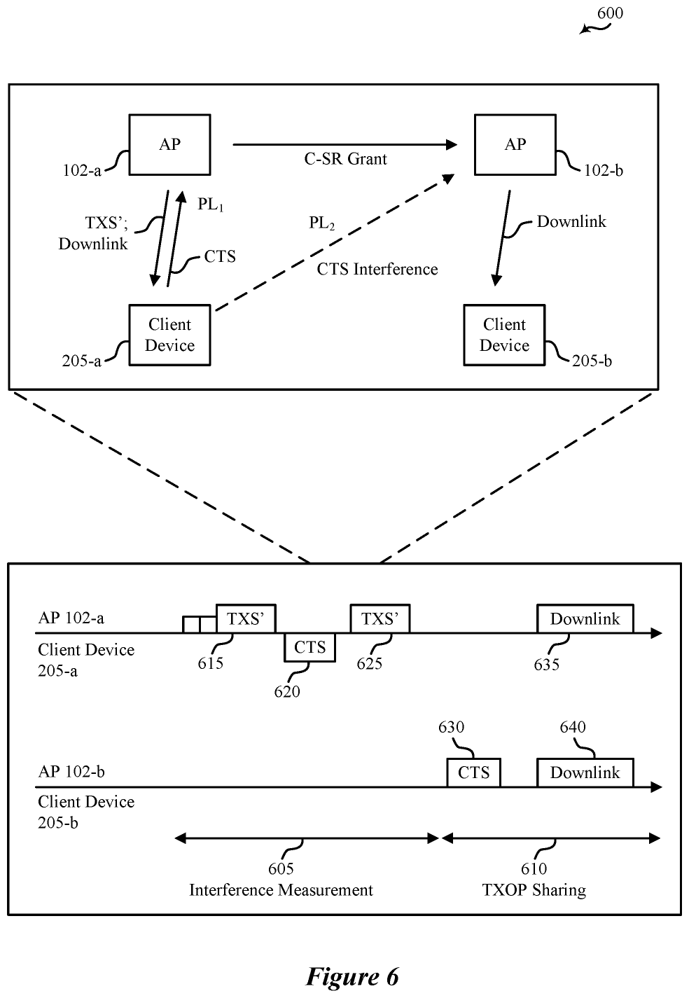

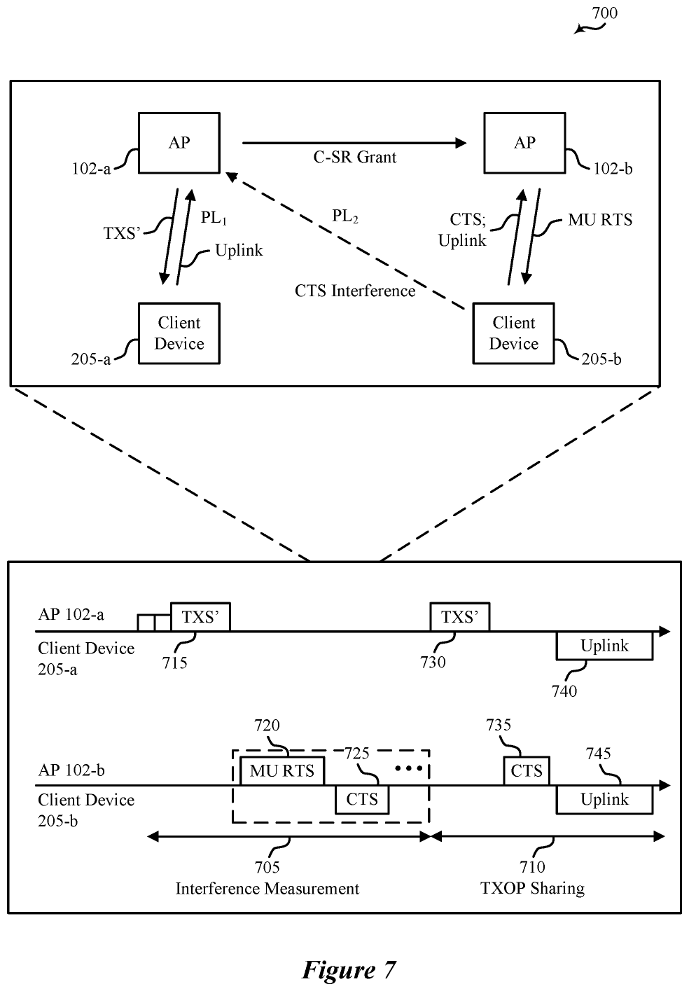

In accordance with a non-UHR-based measurement design (such as a legacy-based measurement principal), the AP 102-a and the AP 102-b may rely on supported frame exchanges, such as control frames including MU RTS or clear-to-send (CTS) frames. In such designs, the AP 102-a (the TXOP-sharing AP 102) may trigger an uplink transmission (such as a control frame, which may be a CTS frame in response to an MU RTS) from a target or principal uplink or downlink client (such as the client device 205-a). The AP 102-a may instruct a neighboring/reuse AP 102 (such as the second AP 102) to measure a receive signal strength indicator (RSSI) of the uplink transmission (such as the control frame, which may be a CTS frame) of the principal client (such as the client device 205-a) and about an upper limit (such as maximum) allowed interference for a reuse transmission. In some aspects, measurements may be performed during each TXOP. The AP 102-b (the TXOP-shared AP 102) may use such information to select, identify, ascertain, or otherwise determine a transmit power for a reuse uplink or downlink transmission. In accordance with such a non-UHR-based measurement design, which may be associated with relatively coarse power control and relatively lower signaling overhead, the AP 102-a and the AP 102-b may support a relatively simple design that may be used to schedule both UHR clients and non-UHR clients for C-SR transmissions. Additional aspects relating to interference management or measurement procedures associated with a non-UHR-based measurement design are illustrated by and described with reference to FIGS. 6 and 7.

In accordance with the interference measurement or management procedure, the AP 102-a or the AP 102-b, or both, may receive, obtain, or otherwise ascertain an interference measurement. The interference measurement may refer to a measurement of interference between the communication link 215-a and the communication link 215-b. In accordance with performing the interference measurement or management procedure, the AP 102-a may transmit TXOP sharing information 220 to the AP 102-b. In some aspects, the TXOP sharing information 220 may include an indication of the TXOP for the AP 102-a (or an indication of an allocation of at least a portion of the TXOP to the AP 102-b) and information associated with the interference measurement between the communication link 215-a and the communication link 215-b. Such information may include an explicit indication of an upper limit transmit power that the AP 102-b may use for uplink or downlink transmissions or an indication of one or more parameters or measurements (such as measurements made at the AP 102-a) that the AP 102-b may use to calculate or compute an upper limit transmit power that the 102-b may use for uplink or downlink transmissions.

In some implementations, the AP 102-b may transmit TXOP sharing capability information 225 to the AP 102-a. In some aspects, the AP 102-b may transmit the TXOP sharing capability information 225 to the AP 102-a in accordance with (such as responsive to) receiving the TXOP sharing information 220. The TXOP sharing capability information 225 may include an indication of whether the AP 102-b intends to transmit or schedule a reuse transmission during the TXOP that is shared with the AP 102-b. For example, the AP 102-b may indicate, via the TXOP sharing capability information 225, whether the AP 102-b is able to satisfy the upper limit transmit power constraint according to which the AP 102-b may share the TXOP. If the AP 102-b does not intend to use or is otherwise unable to use the TXOP that is shared with the AP 102-b, the AP 102-b may include, in the TXOP sharing ability information, information relating to a lower limit (such as minimum) transmit power that the AP 102-b can use (such as to satisfy a quality of service (QoS) or signal-to-interference (SIR) constraint associated with communication at the AP 102-b). In other words, if the AP 102-b is unable to use the upper limit transmit power below which the AP 102-b is allowed to share the TXOP (such as if the upper limit transmit power is insufficient for the AP 102-b), the AP 102-b may indicate that the AP 102-b is unable to satisfy the constraint via the TXOP sharing capability information 225.

In some implementations, the AP 102-a (such as the TXOP owner, which may be referred to as a principal AP 102) may allocate the AP 102-b or another AP 102 a C-SR grant accordingly. In other words, the AP 102-a and the AP 102-b may negotiate one or more operation parameters such as a maximum power backoff, an allowable transmission power, or interference related information (such as a measurement schedule) in accordance with the transmission of the TXOP sharing capability information 225 from the AP 102-b. For example, the AP 102-a may allow some additional transmit power flexibility to enable the AP 102-b to share the TXOP with the AP 102-a or, instead of sharing the TXOP with the AP 102-b, may share the TXOP with another AP 102. In implementations in which the AP 102-a shares the TXOP with another AP 102 (such as in implementations in which an allocation to the AP 102-b is unsuccessful or not used anymore), the AP 102-a may perform medium recovery and allocate resources from the TXOP to another AP 102. Medium recovery may be associated with time (such as a time associated with a SIFS or a point coordination function (PCF) IFS (PIFS) duration recovery) or associated with an indication received from the TXOP-shared AP 102 that receives the grant, where such an indication may be in a frame (such as in a control frame or in a header of a QoS data or null frame, such as in an A-control subfield). In some implementations, the AP 102-b may not transmit the TXOP sharing capability information 225. In such implementations, the AP 102-b may not respond to the TXOP sharing information 220 (such as a frame that allocates the C-SR transmission) if the AP 102-b does not intend to send a reuse transmission using the shared TXOP.

Additionally, or alternatively, the AP 102-b may transmit an indication of a set of one or more TXOP sharing parameters 230. The indication of TXOP sharing parameters 230 may indicate or convey information associated with a set of operation parameters (such as a maximum tolerable power backoff or a minimum transmit power), for either or both of uplink communication and downlink communication, that the AP 102-b may be able to use or comply with while still satisfying one or more QoS constraints or expectations between the AP 102-b and client devices of the AP 102-b. For example, the AP 102-b may transmit the indication of TXOP sharing parameters 230 as part of a negotiation procedure between the AP 102-a and the AP 102-b associated with whether the AP 102-b is able to share the TXOP for the AP 102-a. Further, although illustrated as being transmitted by the AP 102-b, the AP 102-a may additionally, or alternatively, transmit an indication of TXOP sharing parameters to the AP 102-b. Such an indication of TXOP sharing parameters sent by the AP 102-a may be used by the AP 102-b if the AP 102-b acquires the TXOP or may be sent as part of the negotiation procedure between the AP 102-a and the AP 102-b. For example, the indication from the AP 102-a may indicate an updated set of parameters for TXOP sharing with which the AP 102-b is able to comply. Further, the TXOP sharing capability information 225 and the indication of TXOP sharing parameters 230 may be included in a same message or may be transmitted in different messages.

Accordingly, the AP 102-a may conditionally share the TXOP for the AP 102-a with the AP 102-b in accordance with whether the AP 102-b is able to use a transmit power that is less than or equal to an upper limit transmit power, where the upper limit transmit power is associated with a constraint on the AP 102-b such that communication to or from the AP 102-b avoids interfering with (or causes less than a threshold amount of interference) a principal transmission to or from the AP 102-a. As such, the AP 102-a may facilitate greater channel access fairness, which may increase data rates, system throughput, and lower system latency.

Further, although various interference measurement and resource allocation designs are illustrated by and described herein, aspects of one or more of the various interference measurement and resource allocation designs may be implemented in any combination. Additionally, the following aspects may equally apply to the various signaling described herein, specifically with respect to C-SR, TXOP Sharing (TXS′) messaging, and resource polling. As described herein, a TXS' message, which may be referred to as a TXS' frame or TXS' signaling, may be a control frame (such as a Trigger frame, or a Trigger frame variant). For example, a TXS' message may be a variant of an MU RTS TXS Trigger frame and may be used for coordinated AP communication, such as C-TDMA or C-SR. In other words, an MU RTS TXS Trigger frame may be used or extended for coordinated AP communication, and such a differently used or extended MU RTS TXS Trigger frame may be referred to as a TXS' message.

For example, for C-SR, one or both of the AP 102-a or the AP 102-b may use one reserved bit in a User Info field to group APs 102 for C-SR (primary or non-primary), use a C-SR specific User Info field to group APs 102 for C-SR, or may use a Common Info field to carry group information. Additionally, or alternatively, an NP frame (such as a measurement packet frame) may be sent in non-HT duplicate form in an overlapping portion of the coordinating APs 102 (as beacons are sent via a primary channel, there may be scenarios in which the primary channel does not overlap with an operating bandwidth of the other AP 102). Additionally, or alternatively, each AP 102 may announce how much power that AP 102 is willing or able to backoff for C-SR transmission and may indicate a current transmission power of that AP 102 (such as for a measurement packet or a beacon frame, among other examples), which may allow other APs 102 to identify or determine whether they are able to perform C-SR with that AP 102.

In some aspects, each STA 104 (such as each client device) may inform an associated AP 102 how much power that STA 104 is willing or able to backoff for a C-SR uplink transmission and may indicate a current transmission power of the STA 104 (such as during association or after using NP RPT solicited or unsolicited. Additionally, or alternatively, each AP 102 may inform one or more other APs 102 that are participating in the C-SR the upper limit uplink or downlink transmission power or tolerable interference that can be used to determine the transmission power of a secondary or overlapping transmission. Additionally, or alternatively, each AP 102 may announce the schedule at which that AP 102 may transmit measurement packets (such as via a target transmission time or periodicity) to enable other APs 102 and corresponding clients to wake up to receive the measurement packets and measure or estimate an RSSI or pathloss. Additionally, or alternatively, each AP 102 may indicate, to client devices of that AP 102, transmission times of measurement packets from other APs 102 such that the client devices may wake up to receive the measurement packets (via a coordinated TWT (such as a coordinated restricted TWT (C-R-TWT) schedule), beacon announcement, or other broadcast frames). For uplink C-SR transmission at two or more APs 102 in parallel, the APs 102 may align a Trigger frame transmission to avoid interference between the primary client and the secondary client transmission. Additionally, or alternatively, a C-SR grant may indicate that a measurement update is to be performed (such as if SINR is dropping at the primary or principal device or channel).

In some implementations, the AP 102-a and the AP 102-b may negotiate an overlapping coordinated TWT with a set of C-SR parameters to control interference between a primary or principal transmission and one or more secondary or reuse transmissions. Such a negotiation of an overlapping coordinated TWT may be associated with a UHR measurement procedure or a non-UHR measurement procedure. In accordance with a UHR measurement procedure, the AP 102-a and the AP 102-b may achieve relatively more accurate interference measurement. As such, in some implementations, members of the coordinated TWT (which may be an individual TWT (I-TWT), a broadcast TWT (B-TWT), or a restricted TWT (R-TWT)) may be examples of UHR STAs, although non-UHR STAs may not be precluded from the coordinated TWT in some scenarios. Accordingly, in some implementations, the AP 102-b may receive, from the AP 102-a, a frame associated with an overlapping TWT of the AP 102-a and the AP 102-b. In such implementations, the frame may indicate a set of C-SR parameters associated with the overlapping TWT, where the set of C-SR parameters indicated by the frame may be associated with an interference measurement between communication involving the AP 102-a and communication involving the AP 102-b. Further, such a frame may be a request or response frame. For example, the frame may be a TWT request or response frame that includes additional elements or fields to indicate the C-SR parameters.

On TXS' messaging, a transmitting AP 102 may use an order of a user list for scheduling and deferral control. For example, the transmitting AP 102 may use a special value for allocation duration for APs 102 that have been served (such as 0) or those on a waiting list (such as greater than 0). In some aspects, the same information may be carried via a Common Info field. For TXS' messaging with C-SR, the user list may include allocated time domain resources and transmit power control information that is to be used by a receiving, secondary AP 102. In some aspects, a User Info field may allocate resources to each of one or more APs 102 or STAs 104 and the Common Info field may be used to convey information that is applicable to (such as common to) multiple APs 102 or STAs 104 in a same Trigger frame. On resource polling, an AP 102 may solicit a QoS constraint. Such a QoS constraint may include a time-bandwidth demand, a periodicity, or a static or real-time delay bound. Additionally, or alternatively, an AP 102 may solicit an indication of a set of operating channels, C-SR, C-TDMA, or coordinated OFDMA (C-OFDMA) feedback on failures (such as a packet error rate (PER) or an MAC service data unit (MSDU) drop ratio) to assist a scheduler in decision-making.

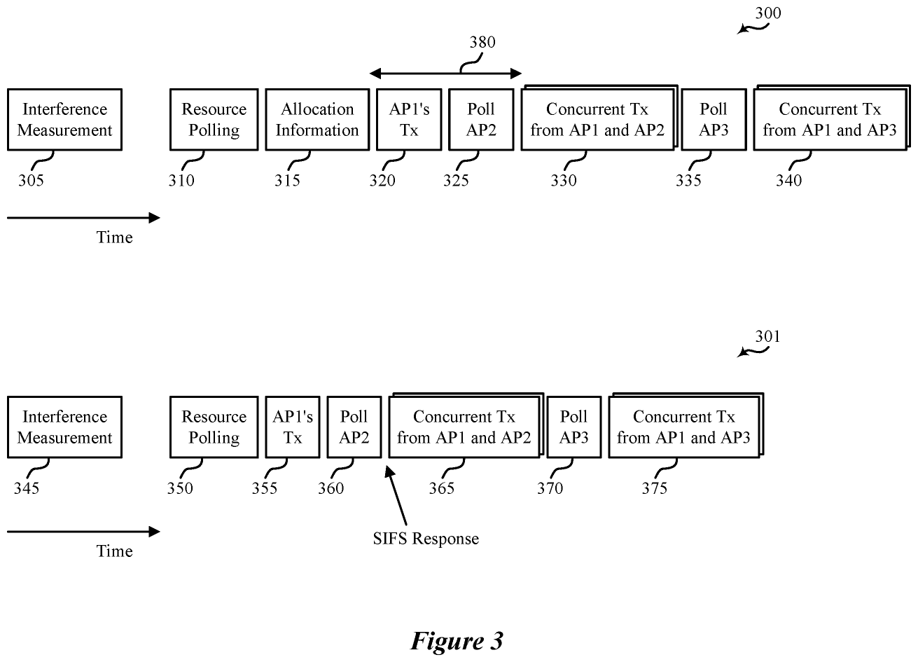

FIG. 3 shows example frame transmission schedules 300 and 301 that support C-SR framework for UHR. The frame transmission schedules 300 and 301 may implement or be implemented to realize or facilitate aspects of the WLAN 100 or the signaling diagram 200. For example, two or more APs 102 may communicate in accordance with one or both of the frame transmission schedule 300 or the frame transmission schedule 301. Such APs 102 may be examples of the APs 102, the AP 102-a, and the AP 102-b as illustrated by and described with reference to FIGS. 1 and 2. In some implementations, the frame transmission schedules 300 and 301 may illustrate two signaling designs according to which a TXOP-sharing AP 102 (such as a first AP 102 or an AP 102-a) may schedule overlapping reuse transmissions with one or more principal transmissions within a TXOP obtained by the TXOP-sharing AP 102.

The frame transmission schedules 300 and 301 may each include an interference measurement according to which an interference may be measured from a TXOP-shared BSS such that a TXOP owner AP 102 may control TXOP-shared AP transmissions. The interference measurement may be scheduled and maintained as a standalone procedure for UHR STAs 104 or may be performed at a TXOP level for non-UHR STAs 104. The frame transmission schedules 300 and 301 may include an optional resource polling according to which feedback may be collected from neighboring APs 102. Such feedback may include a buffer status or C-SR parameters, such as QoS information or transmit power constraints (such as minimum transmit power constraints). Further, feedback for buffer status or C-SR parameters may be transmitted via a MAC frame header, a control frame, or a management frame. In implementations in which the feedback is transmitted via a MAC frame header, the feedback may be included in a variant of an HE Control field, such as an HE variant HT Control field (an A-Control field), an EHT variant HT Control field, or a UHR variant HT Control field. Such resource polling may be a standalone operation or part of the TXOP and may be associated with a control frame-based or management frame-based exchange between APs 102.

The frame transmission schedules 300 and 301 may each include a schedule allocation and data transmission via which an TXOP-sharing AP 102 may advertise, configure, or indicate an allocation of BSS-level resources for data transmissions (per TXOP). For example, the TXOP-sharing AP 102 may inform (such as transmit an indication to) TXOP-shared AP(s) 102 of allocated time resources and of interference or transmit power information within the TXOP. In some aspects, the schedule allocation phase may be performed prior to the data transmission phase, which may allow the one or more TXOP-shared APs 102 to prepare a schedule for their respective BSSs.

In accordance with the frame transmission schedule 300, the TXOP-sharing AP 102 may transmit schedule allocation information upfront, which may give the TXOP-shared AP(s) 102 relatively more time to prepare for transmissions. For example, in accordance with the frame transmission schedule 300, one or more APs 102 may perform an interference measurement at 305 and optional resource polling at 310. The TXOP-sharing AP 102 may transmit allocation information at 315. In some aspects, the allocation information may include a list of shared APs 102. For example, the allocation information may indicate a time domain resource allocation for each AP 102 of a set of APs 102 with which the TXOP-sharing AP 102 shares the TXOP. At 320, the TXOP-sharing AP 102 (which may be referred to as an AP1) may perform a transmission. At 325, the TXOP-sharing AP 102 may poll an AP2 (which may be an example of a TXOP-shared AP 102) and, at 330, the AP1 and the AP2 (the TXOP-sharing AP 102 and one TXOP-shared AP 102) may perform concurrent or at least partially overlapping transmissions. At 335, the TXOP-sharing AP 102 may poll an AP3 (which may be an example of another TXOP-shared AP 102) and, at 340, the AP1 and the AP3 (the TXOP-sharing AP 102 and one TXOP-shared AP 102) may perform concurrent or at least partially overlapping transmissions. In accordance with the frame transmission schedule 300, the AP2 may have a time duration 380 to prepare for a transmission. For example, the time duration 380 may span a time period between the transmission of the allocation information at 315 and the transmission from the AP2 at 330.

In accordance with the frame transmission schedule 301, the TXOP-sharing AP 102 may leverage more responsive TXOP-shared APs 102 (such as TXOP-shared APs that are capable of preparing a PPDU in a SIFS) to achieve lower signaling overhead. For example, one or more APs 102 may perform an interference measurement at 345 and optional resource polling at 350 (which may be performed before or during the TXOP). At 355, the TXOP-sharing AP 102 (which may be referred to as an AP1) may perform a transmission. At 360, the AP1 may poll an AP2 (such as a TXOP-shared AP 102) and, at 365, the AP1 and the AP2 (the TXOP-sharing AP 102 and one TXOP-shared AP 102) may perform concurrent or at least partially overlapping transmissions. At 370, the TXOP-sharing AP 102 (such as the AP1) may poll an AP3 (such as another TXOP-shared AP 102) and, at 375, the AP1 and the AP3 may perform concurrent or at least partially overlapping transmissions. As such, in accordance with the frame transmission schedule 301, the TXOP-sharing AP 102 may share the TXOP without signaling allocation information to the one or more TXOP-shared APs 102.

FIG. 4 shows an example communication timeline 400 that supports C-SR framework for UHR. The communication timeline 400 may implement or be implemented to realize or facilitate aspects of the WLAN 100, the signaling diagram, the frame transmission schedule 300, or the frame transmission schedule 301. For example, the communication timeline 400 illustrates communication between the AP 102-a, the AP 102-b, and the client device 205-a of the AP 102-a, where the AP 102-a, the AP 102-b, and the client device 205-a are additionally illustrated by and described with reference to FIG. 2. In some implementations, the AP 102-a and the AP 102-b may employ the communication timeline 400, which includes an interference measurement phase 405 and a TXOP sharing phase 410, as part of a procedure to protect a principal downlink transmission from a reuse downlink transmission in accordance with a UHR-based measurement design.

For example, in accordance with the communication timeline 400, a client may measure a downlink RSSI from one or more APs 102 at scheduled times and may report the measurements to an AP 102 associated with the client for quality and interference control, such signal-to-interference-plus-noise ratio (SINR) control. For example, the interference measurement phase 405 may include background interference measurement collection according to which one or more APs 102 (such as all involved APs 102) may learn a pathloss for each of their respective client devices with respect to each of one or more neighboring APs 102. For example, the AP 102-a may learn about interference to one or more client devices (such as the client device 205-a) of the AP 102-a that is caused by the AP 102-b.

To establish or configure such interference measurement collection, the AP 102-b may inform (such as transmit an indication to) the AP 102-a of a schedule of measurement packet transmissions from the AP 102-b. A measurement packet may be one of various different frame or packet types. In some implementations, for example, a measurement packet may be a null packet (NP). In some other implementations, a measurement packet may not be an NP. In such implementations, the measurement packet may carry some information, such as an indication of a transmit power. The AP 102-a, in accordance with receiving the schedule of the measurement packet transmissions from the AP 102-b, may notify the client devices (such as the client device 205-a) of the AP 102-a of one or more target measurement packet transmission times from the AP 102-b. Further, in some implementations, the AP 102-a may awake client devices (such as the client device 205-a) of the AP 102-a to measure RSSI of the measurement packets transmitted from the AP 102-b.

Accordingly, the AP 102-b may transmit one or more measurement packets 415 (shown as NPs in the example of FIG. 4) at the target transmission times (and with a transmit power that is known at the AP 102-a and the AP 102-b) and the client device 205-a may obtain one or more link measurements in accordance with measuring interference from the measurement packets 415 transmitted from the AP 102-b. In an example, the AP 102-b may use a transmit power of 30 dBm for the measurement packets 415 and the client device 205-a may measure an RSSI of −80 dBm. Accordingly, the client device 205-a may expect an estimated pathloss of 110 dB from the AP 102-b to the client device 205-a.

The AP 102-a may poll client devices (such as the client device 205-a) of the AP 102-a via a polling message 420 to learn the link measurements obtained by the client devices (such as a measured pathloss or a measured RSSI) from the AP 102-b to the client devices of the AP 102-a. The client device 205-a may transmit a measurement packet report 425 to the AP 102-a including the link measurements obtained by the client device 205-a in accordance with receiving the polling message 420. The AP 102-a may leverage channel reciprocity to estimate downlink SINR at the client devices of the AP 102-a and may transmit TXOP sharing information 430 (which may be illustrated as a TXS' message in the example of FIG. 4) to inform the AP 102-b of an upper limit tolerable transmit power that the AP 102-b may use such that downlink SINR constraints between the AP 102-a and one or more client devices (such as the client device 205-a) are sustained. In other words, the AP 102-a may select or calculate the upper limit tolerable transmit power such that, if the AP 102-b uses a transmit power that is less than or equal to the upper limit tolerable transmit power, the AP 102-b may share the TXOP and transmit concurrently with the AP 102-a without adversely impacting downlink SINR constraints of one or more principal downlink transmissions.

In some implementations, the AP 102-a and the AP 102-b also may exchange additional information, such as an amount of transmit power each AP 102 is able to reduce. Such information may be used by the scheduling AP 102 (such as the AP 102-a) to select time domain resource allocations for different TXOP-shared APs 102. For example, in accordance with receiving an indication of by how much the AP 102-b is able to reduce a transmit power, the AP 102-a may select a time period within the TOXP for the AP 102-a to share with the AP 102-b such that the AP 102-b is likely able to meet the sharing constraints associated with the TXOP without impacting the downlink SINR constraints of the one or more principal downlink transmissions. Further, in some aspects, a periodicity of measurement packet frames (NP frames) may be configured in accordance with an experienced PER during C-SR transmissions or in accordance with feedback from other APs 102, or both. Further, although shown as polling the client device 205-a, the AP 102-a may poll multiple client devices of the AP 102-a simultaneously (or approximately simultaneously) for measurement packet reports (NP reports).

In scenarios in which the AP 102-b is able to use a transmit power that is less than or equal to the upper limit tolerable transmit power indicated by the AP 102-a, the AP 102-b may share the TXOP with the AP 102-a. As such, the AP 102-a and the AP 102-b may perform simultaneous or at least partially overlapping downlink transmissions during the TXOP. Such downlink transmissions may be referred to or understood as C-SR downlink transmissions.

FIG. 5 shows an example communication timeline 500 that supports C-SR framework for UHR. The communication timeline 500 may implement or be implemented to realize or facilitate aspects of the WLAN 100, the signaling diagram, the frame transmission schedule 300, or the frame transmission schedule 301. For example, the communication timeline 500 illustrates communication between the AP 102-a, the AP 102-b, the client device 205-a of the AP 102-a, and the client device 205-b of the AP 102-b, where the AP 102-a, the AP 102-b, the client device 205-a, and the client device 205-b are additionally illustrated by and described with reference to FIG. 2. In some implementations, the AP 102-a and the AP 102-b may employ the communication timeline 500, which includes an interference measurement phase 505 and a TXOP sharing phase 510, as part of a procedure to protect a principal uplink transmission from a reuse uplink transmission in accordance with a UHR-based measurement design.

For example, in accordance with the communication timeline 500, a client may measure a downlink link measurement (such as an RSSI or a pathloss) from APs 102 at scheduled times and may report the measurements to an AP 102 associated with the client for quality and interference control, such as SINR control. For example, the interference measurement phase 505 may include background interference measurement collection according to which one or more APs 102 (such as all involved APs 102) may learn a pathloss for each of their respective client devices with respect to each of one or more neighboring APs 102. For example, the AP 102-b may learn about interference to one or more client devices (such as the client device 205-b) of the AP 102-b that is caused by the AP 102-a.

To establish or configure such interference measurement collection, the AP 102-a may inform (such as via signaling) the AP 102-b of a schedule of measurement packet transmissions from the AP 102-a and the AP 102-b may accordingly notify client devices (such as the client device 205-b) of the AP 102-b about the measurement packet transmission schedule of the AP 102-a. In some aspects, the AP 102-b may awake client devices of the AP 102-b to measure link measurements (such as RSSI or pathloss) of measurement packet transmissions from the AP 102-a. The AP 102-a may transmit one or more measurement packets 515 (shown as NPs in the example of FIG. 5) at the target measurement packet transmission times and the client device 205-b may obtain a link measurement (such as an RSSI value or a pathloss value) associated with receiving interference associated with (such as caused by) one or more of the measurement packets transmitted by the AP 102-a. The AP 102-b may transmit a polling message 520 to the client device 205-b to learn measured RSSI or pathloss from the AP 102-a to the client device 205-b and the client device 205-b may respond with a measurement packet report 525 (an NP report) including the link measurements obtained by the client device 205-b.

The AP 102-a and the AP 102-b may, for uplink SINR, leverage channel reciprocity to estimate uplink SINR and, in terms of the conditional sharing of the TXOP for the AP 102-a with the AP 102-b, the AP 102-a may indicate one or more parameters to the AP 102-b that the AP 102-b may use to calculate an upper limit transmit power that the AP 102-b is allowed to use if the AP 102-b shares the TXOP with the AP 102-a. For example, the AP 102-a may transmit TXOP sharing information 530 (shown as a TXS' message in the example of FIG. 5) to inform the AP 102-b of an upper limit (such as maximum) allowed interference from uplink transmissions of client devices of the AP 102-b (such as the client device 205-b) to the AP 102-a.

The AP 102-a may know a target or expected SIR for uplink transmission at a target or expected modulation and coding scheme (MCS) and may know a target RSSI from client devices of the AP 102-a (such as the client device 205-a) from previous uplink transmissions. In some aspects, the AP 102-a may calculate the target or expected SIR in accordance with SIR=(T₁−PL₁)−(T₂−PL₂), where T₁ is a transmit power of the client device 205-a (the principal client of the AP 102-a), T₂ is a transmit power of the client device 205-b (the reuse client), PL₁ is a pathloss from the client device 205-a to the AP 102-a, and PL₂ is a pathloss from the client device 205-b to the AP 102-a. As such, the AP 102-a may indicate, to the AP 102-b, a target RSSI at the AP 102-a for a reuse uplink transmission. The AP 102-b may obtain the estimated pathloss PL₂ from the client device 205-b (such as via the measurement packer report 525) associated with a measurement packet 515 from the AP 102-a, compute a transmit power T₂=target RSSI from AP 102-a−PL₂, and perform uplink power control for TB PPDUs by setting the transmit power for the client device 205-b using T₂ (which may be added to or included in a Trigger frame, such as a UHR Trigger frame).

In scenarios in which the AP 102-b is able to configure an uplink transmit power that avoids exceeding the upper limit allowed interference indicated by the AP 102-a, the AP 102-b may share the TXOP with the AP 102-a. As such, the AP 102-a and the AP 102-b may trigger and receive simultaneous or at least partially overlapping uplink transmissions during the TXOP. Such uplink transmissions may be referred to or understood as C-SR uplink transmissions and may be TB or non-TB.

FIG. 6 shows an example communication timeline 600 that supports C-SR framework for UHR. The communication timeline 600 may implement or be implemented to realize or facilitate aspects of the WLAN 100, the signaling diagram, the frame transmission schedule 300, or the frame transmission schedule 301. For example, the communication timeline 600 illustrates communication between the AP 102-a, the AP 102-b, the client device 205-a of the AP 102-a, and the client device 205-b of the AP 102-b, where the AP 102-a, the AP 102-b, the client device 205-a, and the client device 205-b are additionally illustrated by and described with reference to FIG. 2. In some implementations, the AP 102-a and the AP 102-b may employ the communication timeline 600, which includes an interference measurement phase 605 and a TXOP sharing phase 610, as part of a procedure to protect a principal downlink transmission from a reuse downlink transmission in accordance with a non-UHR-based measurement design.

In accordance with the communication timeline 600, the AP 102-a and the AP 102-b may support C-SR downlink power control. To facilitate such C-SR downlink power control, the AP 102-a may transmit a frame 615 (shown as a TXS' message in the example of FIG. 6) to one or more client devices of the AP 102-a (such as the client device 205-a). In some aspects, the AP 102-a may transmit the frame 615 to a most challenging downlink client of the AP 102-a, such as a client device most likely to experience interference from the AP 102-b or otherwise most likely to experience communication failures. The frame 615 may include an MU RTS or a TXS' message. The client device 205-a, in accordance with receiving the frame 615, may transmit a response frame 620. The response frame 620 may be a control frame or a management frame. In some aspects, the response frame 620 may include a CTS frame or a BA frame.

In accordance with the interference measurement phase 605, the AP 102-a and the AP 102-b may each obtain a link measurement (such as an RSSI value or a pathloss value) of the response frame 620 transmitted by the client device 205-a. In some aspects, the AP 102-a may measure or learn a value C₁ (such as a receive power of the response frame 620 measured at the AP 102-a) and the AP 102-b may measure or lean a value C₂ (such as a receive power of the response frame 620 measured at the AP 102-b). In some implementations, the AP 102-a may schedule data transmissions with client devices of the AP 102-a prior to transmitting a C-SR grant associated with the TXOP. The AP 102-a may transmit TXOP sharing information 625 (which may be a TXS' message in the example of FIG. 6) to the AP 102-b. The TXOP sharing information 625 may include a C-SR grant and information (through the TXS' message) associated with one or more C-SR parameters that the AP 102-b may use to compute a transmit power for downlink communication from the AP 102-b within the shared TXOP. In some implementations, such a transmit power may be computed such that a target downlink SINR constraint is satisfies at the client device 205-a. The AP 102-b may transmit a frame 630 (which may be a CTS frame in the example of FIG. 6) and, in scenarios in which the AP 102-b is able to use the computed transmit power (such as without adversely impacting an SINR or QoS target at the client device 205-b), the AP 102-a may transmit a downlink message 635 and the AP 102-b may transmit a downlink message 640 concurrently.

The AP 102-a may expect that an SIR between the AP 102-a and the client device 205-a is such that SIR=(T₁−PL₁)−(T₂−PL₂), where T₁ may be a transmit power of the AP 102-a (the principal AP 102), T₂ may be a transmit power of the AP 102-b (the reuse AP 102), PL₁ may be a pathloss from the AP 102-a to the client device 205-a, and PL₂ may be a pathloss from the AP 102-b to the client device 205-a. The AP 102-a may receive an indication of, set, or otherwise configure an SIR constraint to serve the client device 205-a at a given MCS and, accordingly, may calculate an upper limit allowed downlink transmit power from the AP 102-b such that T₂=(T₁−SIR)+(PL₂−PL₁). Both the AP 102-a and the AP 102-b may measure the receive power levels (C₁ and C₂, respectively) of the response frame 620 (such as a CTS frame or a BA frame, or any other control or management frame) transmitted by the client device 205-a in response to the frame 615 sent by the AP 102-a. As such, C₁−C₂=(T_{RF}−PL₁)−(T_{RF}−PL₂)=PL₂−PL₁, where T_{RF} may be a transmit power of the response frame 620. Accordingly, the AP 102-a may transmit, to the AP 102-b via the TXOP sharing information 625 (such as in the TXS' frame) an allocation duration and the C-SR parameters (such as T₁, SIR, and C₁) such that the AP 102-b may compute T₂ in accordance with T₂=(T₁−SIR)+(C₁−C₂), as the AP 102-b may have a value of C₂ already in accordance with measuring the response frame 620 from the client device 205-a.

In some aspects, the AP 102-b may transmit the frame 630 (such as the CTS frame) if the AP 102-b intends to perform a reuse transmission and may refrain from transmitting the frame 630 otherwise. Further, in some implementations, the TXOP sharing information 625 (such as the TXS' message) may include additional padding to allow additional time for the AP 102-b to check or otherwise determine whether the AP 102-b is able to meet T₂ (such as able to use a transmit power that is less than or equal to T₂) and prepare a response (such as a CTS frame or a PPDU, or both). In some implementations, the AP 102-a may schedule another AP 102 during the time domain resources initially allocated for the AP 102-b if the AP 102-a does not receive a response (such as the frame 630, such as a CTS frame) from the AP 102-b that is responsive to the TXOP sharing information 625.

FIG. 7 shows an example communication timeline 700 that supports C-SR framework for UHR. The communication timeline 700 may implement or be implemented to realize or facilitate aspects of the WLAN 100, the signaling diagram, the frame transmission schedule 300, or the frame transmission schedule 301. For example, the communication timeline 700 illustrates communication between the AP 102-a, the AP 102-b, the client device 205-a of the AP 102-a, and the client device 205-b of the AP 102-b, where the AP 102-a, the AP 102-b, the client device 205-a, and the client device 205-b are additionally illustrated by and described with reference to FIG. 2. In some implementations, the AP 102-a and the AP 102-b may employ the communication timeline 700, which includes an interference measurement phase 705 and a TXOP sharing phase 710, as part of a procedure to protect a principal uplink transmission from a reuse uplink transmission in accordance with a non-UHR-based measurement design.

In accordance with the communication timeline 700, the AP 102-a and the AP 102-b may support C-SR uplink power control. To facilitate such C-SR uplink power control, the AP 102-a may opportunistically monitor and measure frames from client devices of the AP 102-b (such as the client device 205-b) and may use a largest measured or learned RSSI (which may be understood as a C₂ value) for power control. For example, the AP 102-a may optionally (such as in some scenarios) transmit a frame 715 (such as a TXS' message) and the AP 102-b may transmit a frame 720 that prompts or triggers one or more frames 725 from client devices of the AP 102-b (such as the client device 205-b). The AP 102-a may transmit the frame 715 to trigger the AP 102-b for measurements and may refrain from transmitting the frame 715 if the AP 102-a expects to obtain measurements more opportunistically from the client devices of the AP 102-b. In some aspects, the AP 102-a may transmit the frame 715 in accordance with winning or obtaining the medium and polling one AP 102 at a time.

As such, the AP 102-a may occasionally or periodically measure the receive power level C₂ of the frames 725 sent by client devices of the AP 102-b and the AP 102-b may record the receive power level of uplink PPDUs sent by client devices of the AP 102-b. Additionally, or alternatively, the AP 102-a may measure the RSSI of TB PPDU transmitted by the client device 205-b, which may be associated with a C₁ value. As such, at least one of the AP 102-a or the AP 102-b has access to or has a recorded value of C₁ (a receive power of an uplink PPDU or measurement packet sent by the client device 205-a or the client device 205-b, collected at the AP 102-a), C₂ (a highest receive power of a frame 725 sent by a client device of the AP 102-b, measured at the AP 102-a), and C₃ (a receive power of an uplink PPDU sent by the client device 205-b, collected at the AP 102-b). In aspects in which the C₁ value is associated with a receive power of a measurement packet sent by the client device 205-b (and measured at the AP 102-a), C₁ may be such that C₁=T_{NP}−PL₂. As such, PL₂=(T_{NP}−C₁) and T_{NP} may be expected to be sent at a maximum transmit power (such as to facilitate a conservative pathloss estimate).

In some aspects, the frame 720 may include an MU RTS frame (which may trigger the client device 205-b to transmit a TB PPDU) and the one or more frames 725 may include one or more CTS frames transmitted by one or more client devices of the AP 102-b. Accordingly, the AP 102-a may opportunistically measure the frames 725 transmitted by the client devices of the AP 102-b and may select, measure, or otherwise identify a strongest (such as greatest) RSSI value associated with at least one of the frames 725. The frame 720 and the one or more frames 725 may or may not be in the same shared TXOP. The AP 102-a may expect that the frames 725 are transmitted at a maximum or upper limit transmit power such that interference from a data transmission may not be larger than that from a frame 725. As such, when the AP 102-a wins or obtains the TXOP and grants C-SR with the AP 102-b, the AP 102-b may indicate a set of one or more constraining C-SR parameters that are associated with (such as depend on) the strongest RSSI received at the AP 102-a from a client device of the AP 102-b.

For example, at the AP 102-a, an SIR may be calculated such that SIR=(T₁−PL₁)−(T₂−PL₂)=C₁−C₂, where the AP 102-a may receive an indication of, set, or otherwise configure a sufficient SIR to serve the client device 205-a at a given MCS and may have access to a C₁ value from previous uplink PPDU transmissions from client devices of the AP 102-a. T₁ may be a transmit power of the client device 205-a (such as the principal client), T₂ may be a transmit power of the client device 205-b (such as the reuse client), PL₁ may be a pathloss from the client device 205-a to the AP 102-a, and PL₂ may be a pathloss from the client device 205-b to the AP 102-a. The AP 102-a may expect that the frame 725 sent by the client device 205-b is transmitted using an upper limit transmission power to facilitate a conservative pathloss estimate and a highest (such as a worst case) C₂.

In some aspects, the AP 102-a may transmit an indication of the one or more C-SR parameters to the AP 102-b via TXOP sharing information 730 (which may be a TXS' message in the example of FIG. 7). The TXOP sharing information 730 may include a C-SR grant and a power backoff for the AP 102-b to use to be able to share the TXOP. The power backoff may be equal to a target SIR minus an experienced SIR without power control (such as C₁−C₂). In some aspects, the AP 102-a may select a relatively conservative C₁ value (such as a smallest C₁ value). In some implementations, the AP 102-b may transmit a frame 735 if the AP 102-b intends to schedule a reuse uplink transmission and may refrain from transmitting the frame 735 if the AP 102-b does not intend to schedule a reuse uplink transmission. The AP 102-b may control a transmission power of the client device 205-b by setting a target RSSI in a Trigger frame to a value equal to C₂ minus the indicated power backoff. In other words, if the AP 102-b is able to satisfy the C-SR parameter constraints, the AP 102-a may transmit an uplink message 740 and the AP 102-b may transmit an uplink message 745 (which may be examples of C-SR triggered uplink messages) and the AP 102-b may configure the client device 205-b such that the uplink transmission from the client device 205-b meets a T₂ constraint (where T₂=(T₁−SIR)+(PL₂−PL₁), as calculated by the AP 102-a or the AP 102-b, or both).

To facilitate decision-making at the AP 102-b relating to whether or not the AP 102-b is to schedule a reuse uplink transmission, the AP 102-a may transmit the TXOP sharing information 730 (such as the TXS' message) to include additional padding to allow the AP 102-b to check if the AP 102-b is able to meet the constraints associated with the indicated C-SR parameters. If the AP 102-b is unable to meet the constraints associated with the indicated C-SR parameters, the AP 102-a may schedule another AP 102. For example, in accordance with receiving an indication that the AP 102-b is unable to satisfy the C-SR parameter constraints or in the absence of a response from the AP 102-b, the AP 102-a may attempt to share the TXOP with another AP 102.

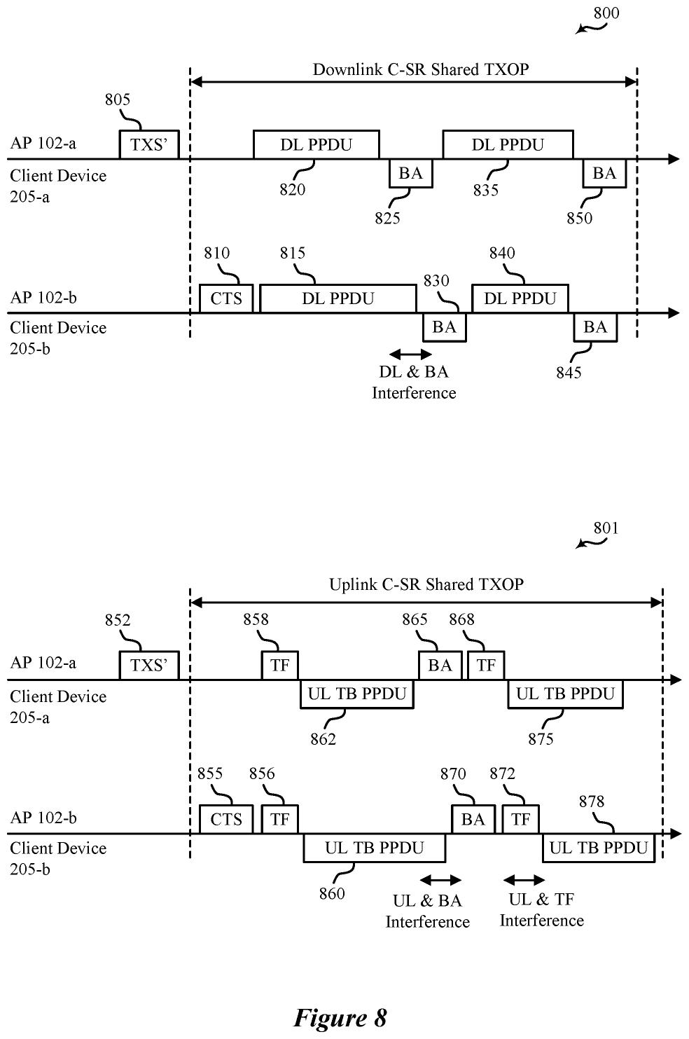

FIG. 8 shows example frame exchanges 800 and 801 that support C-SR framework for UHR. The frame exchanges 800 and 801 may implement or be implemented to realize aspects of the WLAN 100, the signaling diagram 200, the frame transmission schedule 300, the frame transmission schedule 301, or any one or more of the communication timelines 400, 500, 600, or 700. For example, the frame exchanges 800 and 801 illustrate communication between the AP 102-a, the AP 102-b, the client device 205-a of the AP 102-a, and the client device 205-b of the AP 102-b, where the AP 102-a, the AP 102-b, the client device 205-a, and the client device 205-b are additionally illustrated by and described with reference to FIG. 2. In some implementations, the AP 102-a and the AP 102-b may support control frames delivery during C-SR transmissions and may use considerations for interference between control frames and data frames to avoid one or more potential issues associated with an overlapping of control and data frames during C-SR transmissions.

As illustrated by the frame exchange 800, the AP 102-a may transmit a frame 805, which may include TXOP sharing information and may be an example of a TXS' message, and the AP 102-b may transmit a frame 810, which may be a CTS frame. If the AP 102-a and the AP 102-b share the TXOP, the AP 102-a and the AP 102-b may transmit concurrently or during at least a partially overlapping time period. For example, the AP 102-a may transmit a downlink PPDU 820 and the AP 102-b may transmit a downlink PPDU 815. The client device 205-a may transmit a BA 825 associated with the downlink PPDU 820 and the client device 205-b may transmit a BA 830 associated with the downlink PPDU 815. The AP 102-a also may transmit a downlink PPDU 835 and the AP 102-b also may transmit a downlink PPDU 840, and the client device 205-a may transmit a BA 850 associated with the downlink PPDU 835 and the client device 205-b may transmit a BA 845 associated with the downlink PPDU 840.

In some scenarios, the various devices may experience interference between a downlink PPDU and a BA. For example, the downlink PPDU 815 may interfere with the BA 825 in accordance with a misalignment of downlink PPDU transmissions. In such a TXOP sharing implementation for downlink, the AP 102-a may be a BA recipient and it may be suitable for the AP 102-a to receive a BA within another downlink transmission, as APs 102 may naturally be separated from each other (such that the downlink and BA interference is relatively small by nature of a network deployment). This may result in relatively few MAC protocol data unit (MPDU) retransmissions in the downlink.

As illustrated by the frame exchange 801, the AP 102-a may transmit a frame 852, which may include TXOP sharing information and may be an example of a TXS' message, and the AP 102-b may transmit a frame 855, which may be an example of a CTS frame. In examples in which the AP 102-a and the AP 102-b share a TXOP for uplink transmissions, the AP 102-a may transmit a Trigger frame 858 (which may be illustrated as a TF 858 in FIG. 8) that triggers an uplink (UL) TB PPDU 862 and the AP 102-b may transmit a Trigger frame 856 (which may be illustrated as a TF 856 in FIG. 8) that triggers an uplink TB PPDU 860. The AP 102-a may provide feedback associated with the uplink TB PPDU 862 via a BA 865 and the AP 102-b may provide feedback associated with the uplink TB PPDU 860 via a BA 870. The AP 102-a also may transmit a Trigger frame 868 (which may be illustrated as a TF 868 in FIG. 8) that triggers an uplink TB PPDU 875 and the AP 102-b also may transmit a Trigger frame 872 (which may be illustrated as a TF 872 in FIG. 8) that triggers an uplink TB PPDU 878.

In some scenarios, the various devices may experience interference between an uplink PPDU and a BA. For example, the uplink TB PPDU 860 may interfere with the BA 865. Additionally, or alternatively, the various devices may experience interference between an uplink PPDU and a Trigger frame. For example, the uplink TB PPDU 875 may interfere with the Trigger frame 872. In such a TXOP sharing implementation for uplink, the client may be the Trigger frame and BA recipient, where clients may not naturally be separated from each other in a system deployment. For example, the client device 205-a and the client device 205-b may be relatively near each other and uplink transmissions from one client device may interfere with Trigger frame or BA frames to the other client device (such that the Trigger frame or BA frames may fail to be delivered). Such failures may be associated with MPDU loss or false-locking on an OBSS PPDDU.

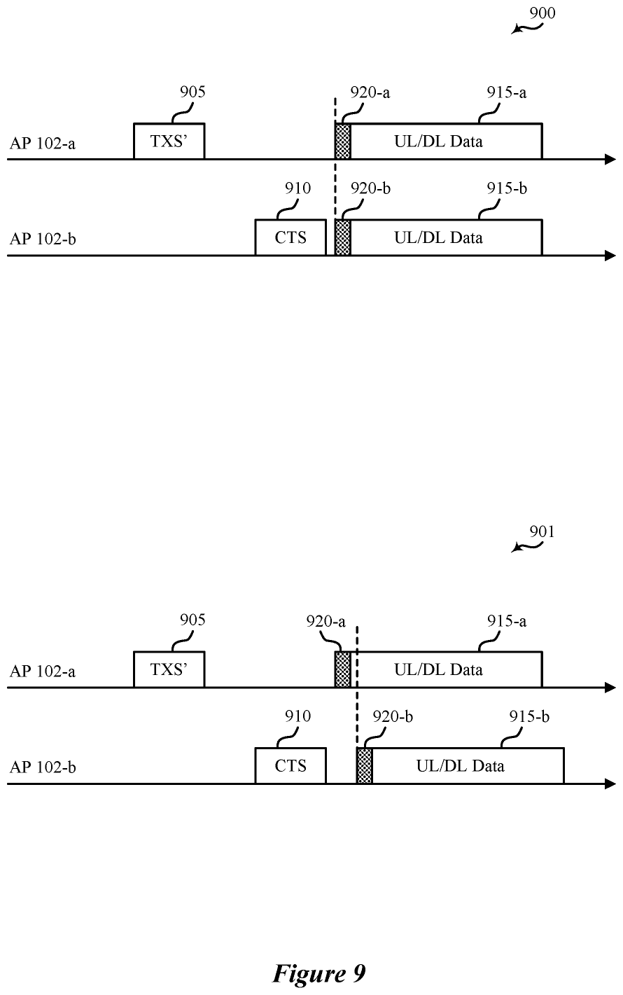

Accordingly, in some implementations, the AP 102-a and the AP 102-b may support a design principle according to which control frames may have higher priority over data frames. In some aspects, control frames may have higher priority over data frames for both principal and reuse transmissions. As such, the AP 102-a and the AP 102-b may allow uplink or downlink control frames and sacrifice one or more MPDU transmissions (as BA decoding may be relatively easier as BAs sometimes use relatively more robust MCSs as compared to data frames or packets). Additionally, or alternatively, the AP 102-a and the AP 102-b may identify or determine whether an SINR is sufficient (such as great enough, or greater than a threshold value) to decode control frames reliably. In some implementations, to increase the likelihood that SINR is sufficient, the AP 102-a or the AP 102-b, or both, may select or otherwise use a reuse factor that is greater than a threshold value (such as a reuse factor that is greater than or equal to 3). In accordance with using a reuse factor that is greater than the threshold value, neighboring APs 102 may more likely use different frequency bands, which may reduce interference between communication involving the AP 102-a and communication involving the AP 102-b. In other words, STA-STA interference may be relatively low, which may reduce a frequency or a likelihood of TF/BA wipe out or false-locking issues. Additionally, or alternatively, the AP 102-a and the AP 102-b may support PPD alignment during conditional TXOP sharing for C-SR, as illustrated by and described in more detail with reference to FIG. 9.

FIG. 9 shows example frame alignments 900 and 901 that support C-SR framework for UHR. The frame alignments 900 and 901 may implement or be implemented to realize aspects of the WLAN 100, the signaling diagram 200, the frame transmission schedule 300, the frame transmission schedule 301, any one or more of the communication timelines 400, 500, 600, 700, the frame exchange 800, or the frame exchange 801. For example, the frame alignments 900 and 901 illustrate communication between the AP 102-a and the AP 102-b, where the AP 102-a and the AP 102-b are additionally illustrated by and described with reference to FIG. 2. The frame alignment 900 and the frame alignment 901 may illustrate different design options associated with PPDU alignment, and the AP 102-a and the AP 102-b may support one or both design options to avoid false-locking at a client device to a wrong AP 102, to achieve greater medium utilization or simpler scheduling, or any combination thereof.

As illustrated by both the frame alignments 900 and 901, the AP 102-a may transmit a frame 905, which may include TXOP sharing information and which may be an example of a TXS' message, and the AP 102-b may transmit a frame 910. In the context of the frame alignment 900, the AP 102-a may transmit a data frame 915-a including a preamble portion 920-a and the AP 102-b may transmit a data frame 915-b including a preamble portion 920-b. In accordance with the design option illustrated by the frame alignment 900, the AP 102-a and the AP 102-b may coordinate such that data frame 915-a and the data frame 915-b are aligned at a starting location (such that the preamble portion 920-a and the preamble portion 920-b start at a same point in time). Such data frames that are associated with same starting locations may be understood as trigger aligned PPDUs and may facilitate greater medium utilization and relatively simpler scheduling. In some aspects, the AP 102-a and the AP 102-b may weigh the greater medium utilization and relatively simpler scheduling with risks of false-locking to an OBSS transmission, where such a risk may depend on SINR, environment, and variation across implementations. In some implementations, the AP 102-a and the AP 102-b may use trigger aligned PPDUs if the AP 102-a and the AP 102-b are separated by a threshold physical distance (such that the AP 102-a and the AP 102-b are far-away APs 102 that yield relatively strong SINRs).

In the context of the frame alignment 901, the AP 102-a and the AP 102-b may stagger or offset a starting point of the data frame 915-a and the data frame 915-b. In some aspects, the AP 102-a and the AP 102-b may stagger or offset the starting points such that the preamble portion 920-a avoids overlapping with the preamble portion 920-b. Such data frames that are staggered or offset in the time domain may be understood as trigger staggered PPDUs and may facilitate relatively greater robustness to false-locking. In some aspects, the AP 102-a and the AP 102-b may weigh the relatively greater robustness to false-locking with slightly lower medium utilization, which may be negligible as compared to the TXOP duration in the order of milliseconds.

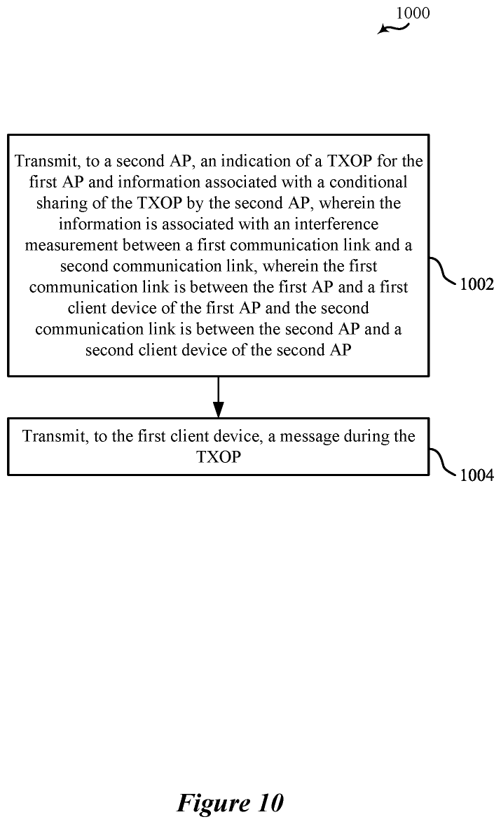

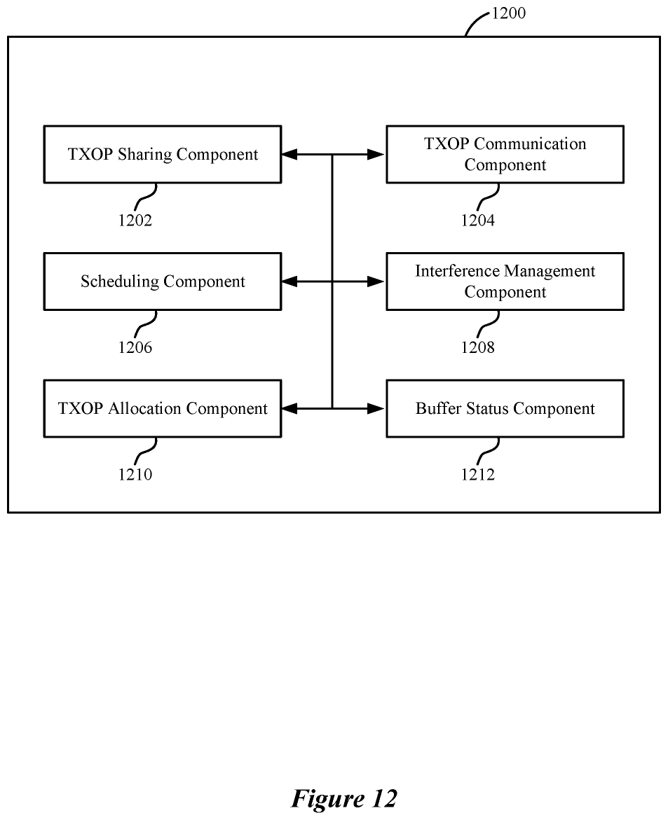

FIG. 10 shows a flowchart illustrating an example process 1000 performable at a wireless AP that supports C-SR framework for UHR. The operations of the process 1000 may be implemented by a wireless AP or its components as described herein. For example, the process 1000 may be performed by a wireless communication device, such as the wireless communication device 1200 described with reference to FIG. 12, operating as or within a wireless AP. In some implementations, the process 1000 may be performed by a wireless AP such as one of the APs 102 described with reference to FIG. 1.

At 1002, a first AP may transmit, to a second AP, an indication of a TXOP for the first AP and information associated with a conditional sharing of the TXOP by the second AP, where the information is associated with an interference measurement between a first communication link and a second communication link, where the first communication link is between the first AP and a first client device of the first AP and the second communication link is between the second AP and a second client device of the second AP. The operations of 1002 may be performed in accordance with examples as disclosed herein.

At 1004, the first AP may transmit, to the first client device, a message during the TXOP. The operations of 1004 may be performed in accordance with examples as disclosed herein.

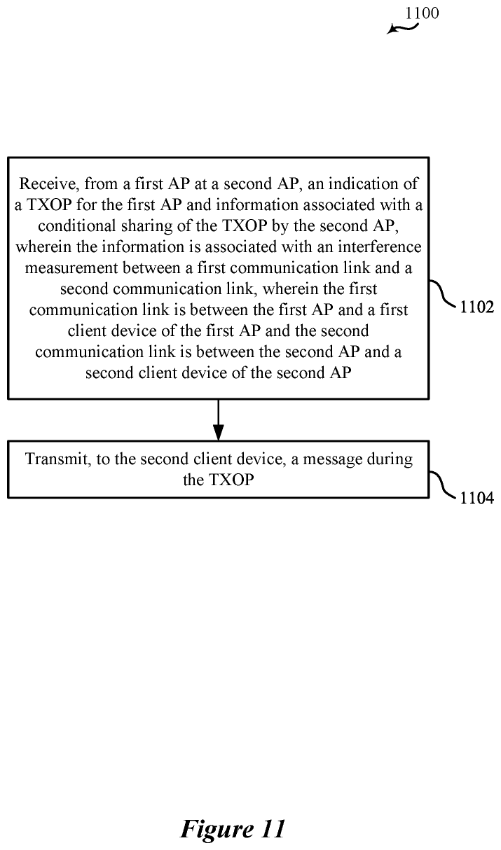

FIG. 11 shows a flowchart illustrating an example process 1100 performable at a wireless AP that supports C-SR framework for UHR. The operations of the process 1100 may be implemented by a wireless AP or its components as described herein. For example, the process 1100 may be performed by a wireless communication device, such as the wireless communication device 1200 described with reference to FIG. 12, operating as or within a wireless AP. In some implementations, the process 1100 may be performed by a wireless AP such as one of the APs 102 described with reference to FIG. 1.

At 1102, a second AP may receive, from a first AP at a second AP, an indication of a TXOP for the first AP and information associated with a conditional sharing of the TXOP by the second AP, where the information is associated with an interference measurement between a first communication link and a second communication link, where the first communication link is between the first AP and a first client device of the first AP and the second communication link is between the second AP and a second client device of the second AP. The operations of 1102 may be performed in accordance with examples as disclosed herein.

At 1104, the second AP may transmit, to the second client device, a message during the TXOP. The operations of 1104 may be performed in accordance with examples as disclosed herein.

FIG. 12 shows a block diagram of an example wireless communication device 1200 that supports C-SR framework for UHR. In some implementations, the wireless communication device 1200 is configured or operable to perform the process 1000 and or the process 1100 described with reference to FIG. 10 or FIG. 11. In various examples, the wireless communication device 1200 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

In some implementations, the wireless communication device 1200 can be a device for use in an AP, such as AP 102 described with reference to FIG. 1. In some other examples, the wireless communication device 1200 can be an AP that includes such a chip, SoC, chipset, package or device as well as multiple antennas. The wireless communication device 1200 is capable of transmitting and receiving wireless communications in the form of, for example, wireless packets. For example, the wireless communication device 1200 can be configured or operable to transmit and receive packets in the form of physical layer PPDUs and MPDUs conforming to one or more of the IEEE 802.11 family of wireless communication protocol standards. In some implementations, the wireless communication device 1200 also includes or can be coupled with an application processor which may be further coupled with another memory. In some implementations, the wireless communication device 1200 further includes at least one external network interface that enables communication with a core network or backhaul network to gain access to external networks including the Internet.

The wireless communication device 1200 includes a TXOP sharing component 1202, a TXOP communication component 1204, a scheduling component 1206, an interference management component 1208, a TXOP allocation component 1210, a buffer status component 1212, or any combination thereof. Portions of one or more of the components 1202, 1204, 1206, 1208, 1210 and 1212 may be implemented at least in part in hardware or firmware. For example, the TXOP communication component 1204 may be implemented at least in part by a modem. In some implementations, at least some of the components 1202, 1204, 1206, 1208, 1210 and 1212 are implemented at least in part by a processor and as software stored in a memory. For example, portions of one or more of the components 1202, 1204, 1206, 1208, 1210 or 1212 can be implemented as non-transitory instructions (or “code”) executable by the processor to perform the functions or operations of the respective module

In some implementations, the processor may be a component of a processing system. A processing system may generally refer to a system or series of machines or components that receives inputs and processes the inputs to produce a set of outputs (which may be passed to other systems or components of, for example, the device 1200). For example, a processing system of the device 1200 may refer to a system including the various other components or subcomponents of the device 1200, such as the processor, or a transceiver, or a communications manager, or other components or combinations of components of the device 1200. The processing system of the device 1200 may interface with other components of the device 1200, and may process information received from other components (such as inputs or signals) or output information to other components. For example, a chip or modem of the device 1200 may include a processing system, a first interface to output information and a second interface to obtain information. In some implementations, the first interface may refer to an interface between the processing system of the chip or modem and a transmitter, such that the device 1200 may transmit information output from the chip or modem. In some implementations, the second interface may refer to an interface between the processing system of the chip or modem and a receiver, such that the device 1200 may obtain information or signal inputs, and the information may be passed to the processing system. A person having ordinary skill in the art will readily recognize that the first interface also may obtain information or signal inputs, and the second interface also may output information or signal outputs.

The TXOP sharing component 1202 may be capable of, configured to, or operable to transmit, to a second AP, an indication of a TXOP for the first AP and information associated with a conditional sharing of the TXOP by the second AP, where the information is associated with an interference measurement between a first communication link and a second communication link, where the first communication link is between the first AP and a first client device of the first AP and the second communication link is between the second AP and a second client device of the second AP. The TXOP communication component 1204 may be capable of, configured to, or operable to transmit, to the first client device, a message during the TXOP.

The scheduling component 1206 may be capable of, configured to, or operable to receive, from the second AP, an indication of a schedule of measurement packets from the second AP. In some implementations, the scheduling component 1206 may be capable of, configured to, or operable to transmit, to the first client device, an indication of one or more transmissions times of the measurement packets from the second AP, where the one or more transmission times are associated with the schedule, and where the interference measurement is associated with the measurement packets from the second AP.

The interference management component 1208 may be capable of, configured to, or operable to transmit, to the first client device, a frame requesting link measurements associated with the measurement packets from the second AP. In some implementations, the interference management component 1208 may be capable of, configured to, or operable to receive, from the first client device, the link measurements associated with the measurement packets from the second AP, where the interference measurement is associated with the link measurements.

To support transmitting the information associated with the conditional sharing of the TXOP by the second AP, the TXOP sharing component 1202 may be capable of, configured to, or operable to transmit an indication of an upper limit transmit power of the second AP in accordance with the link measurements received from the first client device, where the indication of the upper limit transmit power indicates that the second AP is able to share the TXOP with the first AP if the second AP uses a transmit power that is less than or equal to the upper limit transmit power.

The schedule of the measurement packets from the second AP are associated with a transmit power. In some implementations, the first AP receives an indication of the transmit power from the second AP or the measurement packets indicate the transmit power.

The scheduling component 1206 may be capable of, configured to, or operable to transmit, to the second AP, an indication of a schedule of measurement packets from the first AP. In some implementations, the interference management component 1208 may be capable of, configured to, or operable to transmit the measurement packets in accordance with the schedule.

To support transmitting the information associated with the conditional sharing of the TXOP by the second AP, the TXOP sharing component 1202 may be capable of, configured to, or operable to transmit an indication of an upper limit interference level, at the first AP, from uplink transmissions from the second client device, where the indication of the upper limit interference level indicates that the second AP is able to share the TXOP with the first AP if the second AP configures an uplink transmit power that is associated with an interference level, at the first AP, that is less than or equal to the upper limit interference level.

The interference management component 1208 may be capable of, configured to, or operable to transmit, to the first client device, a frame that triggers a response frame from the first client device.

To support transmitting the information associated with the conditional sharing of the TXOP by the second AP, the TXOP sharing component 1202 may be capable of, configured to, or operable to transmit a message including an indication of a transmit power of the first AP, an indication of a target SIR between the first AP and the first client device, and an indication of a first receive power of the response frame at the first AP, where an upper limit transmit power of the second AP is associated with the transmit power of the first AP, the target SIR, the first receive power of the response frame at the first AP, and a second receive power of the response frame at the second AP, and where the message indicates that the second AP is able to share the TXOP with the first AP if the second AP uses a transmit power that is less than or equal to the upper limit transmit power.

The interference management component 1208 may be capable of, configured to, or operable to receive one or more frames from one or more client devices of the second AP, where the interference measurement is associated with a strongest receive power, at the first AP, of the one or more frames received from the one or more client devices of the second AP.

The interference management component 1208 may be capable of, configured to, or operable to transmit, to the second AP, a frame that triggers the interference measurement, where receiving the one or more frames from the one or more client devices of the second AP is associated with transmitting the frame that triggers the interference measurement.

To support transmitting the information associated with the conditional sharing of the TXOP by the second AP, the TXOP sharing component 1202 may be capable of, configured to, or operable to transmit an indication of an uplink power backoff associated with the strongest receive power of the one or more frames, where the indication of the uplink power backoff indicates that the second AP is able to share the TXOP with the first AP if the second AP uses the uplink power backoff for uplink transmissions to the second AP.

To support transmitting the indication of the TXOP for the first AP and the information associated with the conditional sharing of the TXOP by the second AP, the TXOP allocation component 1210 may be capable of, configured to, or operable to transmit an indication of allocation information associated with the TXOP, where the allocation information indicates a respective time domain resource allocation, within the TXOP, for communication by a respective AP of a set of APs with which the TXOP is conditionally shared, where the set of APs with which the TXOP is conditionally shared includes the second AP.

The buffer status component 1212 may be capable of, configured to, or operable to transmit, to the second AP, a request for a buffer status of the second AP, a QoS associated with the second AP, or a target transmit power of the second AP, where transmitting the indication of the TXOP for the first AP and the information associated with the conditional sharing of the TXOP by the second AP is associated with the buffer status of the second AP, the QoS associated with the second AP, or the target transmit power of the second AP.

To support transmitting the indication of the TXOP for the first AP, the TXOP allocation component 1210 may be capable of, configured to, or operable to transmit a frame that allocates the conditional sharing of the TXOP with the second AP, where the frame includes one or both of an indication of a communication schedule between the first AP and the first client device or padding, and where the communication schedule or the padding are associated with facilitating use of the TXOP at the second AP.

The TXOP sharing component 1202 may be capable of, configured to, or operable to receive, from the second AP, an indication that the second AP is unable to share the TXOP in accordance with the information associated with the conditional sharing of the TXOP.

In some implementations, the message includes a control frame. In some implementations, the first AP and the second AP communicate using different frequency channels in accordance with a reuse factor associated with the first AP and the second AP. In some implementations, the first AP and the second AP share the TXOP during a TXOP associated with the control frame in accordance with the first AP and the second AP using the different frequency channels.

In some implementations, the information associated with the conditional sharing of the TXOP by the second AP includes an indication that the second AP is able to share the TXOP in accordance with an alignment between first transmissions associated with the first communication link and second transmissions associated with the second communication link. In some implementations, the alignment includes a start time alignment or a staggered start time alignment.

In some implementations, the information associated with the conditional sharing of the TXOP by the second AP indicates a time domain resource allocation, within the TXOP, for the second AP and indicates an interference constraint or a transmit power constraint, or both, for the second AP to satisfy to be able to transmit or receive during the time domain resource allocation.

In some implementations, the message includes a downlink data message, or includes a frame that triggers an uplink data message from the first client device.

The TXOP sharing component 1202 may be capable of, configured to, or operable to receive, from a first AP at a second AP, an indication of a transmission opportunity (TXOP) for the first AP and information associated with a conditional sharing of the TXOP by the second AP, where the information is associated with an interference measurement between a first communication link and a second communication link, where the first communication link is between the first AP and a first client device of the first AP and the second communication link is between the second AP and a second client device of the second AP. In some implementations, the TXOP communication component 1204 may be capable of, configured to, or operable to transmit, to the second client device, a message during the TXOP.

The scheduling component 1206 may be capable of, configured to, or operable to transmit, to the first AP, an indication of a schedule of measurement packets from the second AP, where the interference measurement is associated with the measurement packets from the second AP.

To support receiving the information associated with the conditional sharing of the TXOP by the second AP, the interference management component 1208 may be capable of, configured to, or operable to receive an indication of an upper limit transmit power of the second AP, where the upper limit transmit power is associated with link measurements of the measurement packets from the second AP, and where the indication of the upper limit transmit power indicates that the second AP is able to share the TXOP with the first AP if the second AP uses a transmit power that is less than or equal to the upper limit transmit power.

The scheduling component 1206 may be capable of, configured to, or operable to receive, from the first AP, an indication of a schedule of measurement packets from the first AP. In some implementations, the scheduling component 1206 may be capable of, configured to, or operable to transmit, to the second client device, an indication of one or more transmissions times of the measurement packets from the first AP, where the one or more transmission times are associated with the schedule, and where the interference measurement is associated with the measurement packets from the first AP.

The interference management component 1208 may be capable of, configured to, or operable to transmit, to the second client device, a frame requesting link measurements associated with the measurement packets from the first AP. In some implementations, the interference management component 1208 may be capable of, configured to, or operable to receive, from the second client device, the link measurements associated with the measurement packets from the first AP, where the interference measurement is associated with the link measurements.

To support receiving the information associated with the conditional sharing of the TXOP by the second AP, the TXOP sharing component 1202 may be capable of, configured to, or operable to receive an indication of an upper limit interference level, at the first AP, from uplink transmissions from the second client device, where the indication of the upper limit interference level indicates that the second AP is able to share the TXOP with the first AP if the second AP configures an uplink transmit power that is associated with an interference level, at the first AP, that is less than or equal to the upper limit interference level, and where the interference level at the first AP is associated with the link measurements received from the second client device.

To support transmitting the message, the interference management component 1208 may be capable of, configured to, or operable to transmit a control frame that indicates an upper limit transmit power for the second client device in accordance with the upper limit interference level, where the uplink transmit power is less than or equal to the upper limit transmit power.

The interference management component 1208 may be capable of, configured to, or operable to receive one or more frames from one or more client devices of the first AP, where the interference measurement is associated with a strongest receive power, at the second AP, of the one or more frames received from the one or more client devices of the first AP.

To support receiving the information associated with the conditional sharing of the TXOP by the second AP, the TXOP sharing component 1202 may be capable of, configured to, or operable to receive a message including an indication of a transmit power of the first AP, an indication of a target SIR between the first AP and the first client device, and an indication of a receive power of a frame, of the one or more frames, at the first AP, where an upper limit transmit power of the second AP is associated with the transmit power of the first AP, the target SIR, the receive power at the first AP, and the strongest receive power at the second AP, and where the message indicates that the second AP is able to share the TXOP with the first AP if the second AP uses a transmit power that is less than or equal to the upper limit transmit power.

The interference management component 1208 may be capable of, configured to, or operable to transmit, to the second client device, a Trigger frame that triggers an uplink transmission or a peer-to-peer transmission from the second client device and that indicates the transmit power that is less than or equal to the upper limit transmit power.

The interference management component 1208 may be capable of, configured to, or operable to transmit, to one or more client devices of the second AP, a frame that triggers one or more response frames from the one or more client devices of the second AP.

The interference management component 1208 may be capable of, configured to, or operable to receive, from the first AP, a second frame that triggers the interference measurement, where transmitting the frame that triggers the one or more response frames is associated with receiving the second frame that triggers the interference measurement.

To support receiving the information associated with the conditional sharing of the TXOP by the second AP, the TXOP sharing component 1202 may be capable of, configured to, or operable to receive an indication of an uplink power backoff, where the uplink power backoff is associated with the one or more frames, and where the indication of the uplink power backoff indicates that the second AP is able to share the TXOP with the first AP if the second AP uses the uplink power backoff for uplink transmissions to the second AP.

To support receiving the indication of the TXOP for the first AP and the information associated with the conditional sharing of the TXOP by the second AP, the TXOP allocation component 1210 may be capable of, configured to, or operable to receive an indication of allocation information associated with the TXOP, where the allocation information indicates a respective time domain resource allocation, within the TXOP, for communication by a respective AP of a set of APs with which the TXOP is conditionally shared, where the set of APs with which the TXOP is conditionally shared includes the second AP.

The buffer status component 1212 may be capable of, configured to, or operable to receive, from the first AP, a request for a buffer status of the second AP, a QoS associated with the second AP, or a target transmit power of the second AP, where receiving the indication of the TXOP for the first AP and the information associated with the conditional sharing of the TXOP by the second AP is associated with the buffer status of the second AP, the QoS associated with the second AP, or the target transmit power of the second AP.

To support receiving the indication of the TXOP for the first AP, the TXOP sharing component 1202 may be capable of, configured to, or operable to receive a frame that allocates the conditional sharing of the TXOP with the second AP, where the frame includes one or both of an indication of a communication schedule between the first AP and the first client device or padding, and where the communication schedule or the padding are associated with enabling a use of the TXOP at the second AP.

The TXOP allocation component 1210 may be capable of, configured to, or operable to transmit, to the first AP, an indication of a minimum transmit power associated with the second communication link between the second AP and the second client device, where receiving the frame that allocates the conditional sharing of the TXOP is associated with the indication of the minimum transmit power.

In some implementations, the message includes a control frame. In some implementations, the first AP and the second AP communicate using different frequency channels in accordance with a reuse factor associated with the first AP and the second AP. In some implementations, the first AP and the second AP share the TXOP during a TXOP associated with the control frame in accordance with the first AP and the second AP using the different frequency channels.

In some implementations, the information associated with the conditional sharing of the TXOP by the second AP includes an indication that the second AP is able to share the TXOP in accordance with an alignment between first transmissions associated with the first communication link and second transmissions associated with the second communication link. In some implementations, the alignment includes a start time alignment or a staggered start time alignment.

In some implementations, the information associated with the conditional sharing of the TXOP by the second AP indicates a time domain resource allocation, within the TXOP, for the second AP and indicates an interference constraint or a transmit power constraint, or both, for the second AP to satisfy to be able to transmit or receive during the time domain resource allocation.

In some implementations, the message includes a downlink data message, or includes a frame that triggers an uplink data message from the second client device.

Implementation examples are described in the following numbered clauses:

Clause 1: An apparatus for wireless communication at a first AP, including: one or more interfaces configured to: output, to a second AP, an indication of a TXOP for the first AP and information associated with a conditional sharing of the TXOP by the second AP, where the information is associated with an interference measurement between a first communication link and a second communication link, where the first communication link is between the first AP and a first client device of the first AP and the second communication link is between the second AP and a second client device of the second AP; and output, to the first client device, a message during the TXOP.

Clause 2: The apparatus of clause 1, where the one or more interfaces are further configured to: obtain, from the second AP, an indication of a schedule of measurement packets from the second AP; and output, to the first client device, an indication of one or more transmissions times of the measurement packets from the second AP, where the one or more transmission times are associated with the schedule, and where the interference measurement is associated with the measurement packets from the second AP.

Clause 3: The apparatus of clause 2, where the one or more interfaces are further configured to: output, to the first client device, a frame requesting link measurements associated with the measurement packets from the second AP; and obtain, from the first client device, the link measurements associated with the measurement packets from the second AP, where the interference measurement is associated with the link measurements.

Clause 4: The apparatus of clause 3, where, to output the information associated with the conditional sharing of the TXOP by the second AP, the one or more interfaces are configured to: output an indication of an upper limit transmit power of the second AP in accordance with the link measurements obtained from the first client device, where the indication of the upper limit transmit power indicates that the second AP is able to share the TXOP with the first AP if the second AP uses a transmit power that is less than or equal to the upper limit transmit power.

Clause 5: The apparatus of any of clauses 2 through 4, where the schedule of the measurement packets from the second AP are associated with a transmit power, and the first AP obtains an indication of the transmit power from the second AP or the measurement packets indicate the transmit power.

Clause 6: The apparatus of any of clauses 1 through 5, where the one or more interfaces are further configured to: output, to the second AP, an indication of a schedule of measurement packets from the first AP; and output the measurement packets in accordance with the schedule.

Clause 7: The apparatus of clause 6, where, to output the information associated with the conditional sharing of the TXOP by the second AP, the one or more interfaces are configured to: output an indication of an upper limit interference level, at the first AP, from uplink transmissions from the second client device, where the indication of the upper limit interference level indicates that the second AP is able to share the TXOP with the first AP if the second AP configures an uplink transmit power that is associated with an interference level, at the first AP, that is less than or equal to the upper limit interference level.

Clause 8: The apparatus of any of clauses 1 through 7, where the one or more interfaces are further configured to: output, to the first client device, a frame that triggers a response frame from the first client device.

Clause 9: The apparatus of clause 8, where, to output the information associated with the conditional sharing of the TXOP by the second AP, the one or more interfaces are configured to: output a message including an indication of a transmit power of the first AP, an indication of a target SIR between the first AP and the first client device, and an indication of a first receive power of the response frame at the first AP, where an upper limit transmit power of the second AP is associated with the transmit power of the first AP, the target SIR, the first receive power of the response frame at the first AP, and a second receive power of the response frame at the second AP, and where the message indicates that the second AP is able to share the TXOP with the first AP if the second AP uses a transmit power that is less than or equal to the upper limit transmit power.

Clause 10: The apparatus of any of clauses 1 through 9, where the one or more interfaces are further configured to: obtain one or more frames from one or more client devices of the second AP, where the interference measurement is associated with a strongest receive power, at the first AP, of the one or more frames obtained from the one or more client devices of the second AP.

Clause 11: The apparatus of clause 10, where the one or more interfaces are further configured to: output, to the second AP, a frame that triggers the interference measurement, where obtaining the one or more frames from the one or more client devices of the second AP is associated with outputting the frame that triggers the interference measurement.

Clause 12: The apparatus of any of clauses 10 through 11, where, to output the information associated with the conditional sharing of the TXOP by the second AP, the one or more interfaces are configured to: output an indication of an uplink power backoff associated with the strongest receive power of the one or more frames, where the indication of the uplink power backoff indicates that the second AP is able to share the TXOP with the first AP if the second AP uses the uplink power backoff for uplink transmissions to the second AP.

Clause 13: The apparatus of any of clauses 1 through 12, where, to output the indication of the TXOP for the first AP and the information associated with the conditional sharing of the TXOP by the second AP, the one or more interfaces are configured to: output an indication of allocation information associated with the TXOP, where the allocation information indicates a respective time domain resource allocation, within the TXOP, for communication by a respective AP of a set of APs with which the TXOP is conditionally shared, where the set of APs with which the TXOP is conditionally shared includes the second AP.

Clause 14: The apparatus of any of clauses 1 through 13, where the one or more interfaces are further configured to: output, to the second AP, a request for a buffer status of the second AP, a QoS associated with the second AP, or a target transmit power of the second AP, where outputting the indication of the TXOP for the first AP and the information associated with the conditional sharing of the TXOP by the second AP is associated with the buffer status of the second AP, the QoS associated with the second AP, or the target transmit power of the second AP.

Clause 15: The apparatus of any of clauses 1 through 14, where, to output the indication of the TXOP for the first AP, the one or more interfaces are configured to: output a frame that allocates the conditional sharing of the TXOP with the second AP, where the frame includes one or both of an indication of a communication schedule between the first AP and the first client device or padding, and where the communication schedule or the padding are associated with facilitating use of the TXOP at the second AP.

Clause 16: The apparatus of clause 15, where the one or more interfaces are further configured to: obtain, from the second AP, an indication that the second AP is unable to share the TXOP in accordance with the information associated with the conditional sharing of the TXOP.

Clause 17: The apparatus of any of clauses 1 through 16, where the message includes a control frame, the first AP and the second AP communicate using different frequency channels in accordance with a reuse factor associated with the first AP and the second AP, and the first AP and the second AP share the TXOP during a TXOP associated with the control frame in accordance with the first AP and the second AP using the different frequency channels.

Clause 18: The apparatus of any of clauses 1 through 17, where the information associated with the conditional sharing of the TXOP by the second AP includes an indication that the second AP is able to share the TXOP in accordance with an alignment between first transmissions associated with the first communication link and second transmissions associated with the second communication link, and the alignment includes a start time alignment or a staggered start time alignment.

Clause 19: The apparatus of any of clauses 1 through 18, where the information associated with the conditional sharing of the TXOP by the second AP indicates a time domain resource allocation, within the TXOP, for the second AP and indicates an interference constraint or a transmit power constraint, or both, for the second AP to satisfy to be able to output or obtain during the time domain resource allocation.

Clause 20: The apparatus of any of clauses 1 through 19, where the message includes a downlink data message, or includes a frame that triggers an uplink data message from the first client device.

Clause 21: The apparatus of any of clauses 1 through 20, where, in addition to having one or more interfaces, the apparatus for wireless communication at the first AP can include a processing system capable of (or configured to) to implement the innovative features of the disclosure.

Clause 22: An apparatus for wireless communication, including: one or more interfaces configured to: obtain, from a first AP at a second AP, an indication of a TXOP for the first AP and information associated with a conditional sharing of the TXOP by the second AP, where the information is associated with an interference measurement between a first communication link and a second communication link, where the first communication link is between the first AP and a first client device of the first AP and the second communication link is between the second AP and a second client device of the second AP; and output, to the second client device, a message during the TXOP.

Clause 23: The apparatus of clause 22, where the one or more interfaces are further configured to: output, to the first AP, an indication of a schedule of measurement packets from the second AP, where the interference measurement is associated with the measurement packets from the second AP.

Clause 24: The apparatus of clause 23, where, to obtain the information associated with the conditional sharing of the TXOP by the second AP, the one or more interfaces are configured to: obtain an indication of an upper limit transmit power of the second AP, where the upper limit transmit power is associated with link measurements of the measurement packets from the second AP, and where the indication of the upper limit transmit power indicates that the second AP is able to share the TXOP with the first AP if the second AP uses a transmit power that is less than or equal to the upper limit transmit power.

Clause 25: The apparatus of any of clauses 22 through 24, where the one or more interfaces are further configured to: obtain, from the first AP, an indication of a schedule of measurement packets from the first AP; and output, to the second client device, an indication of one or more transmissions times of the measurement packets from the first AP, where the one or more transmission times are associated with the schedule, and where the interference measurement is associated with the measurement packets from the first AP.

Clause 26: The apparatus of clause 25, where the one or more interfaces are further configured to: output, to the second client device, a frame requesting link measurements associated with the measurement packets from the first AP; and obtain, from the second client device, the link measurements associated with the measurement packets from the first AP, where the interference measurement is associated with the link measurements.

Clause 27: The apparatus of clause 26, where, to obtain the information associated with the conditional sharing of the TXOP by the second AP, the one or more interfaces are configured to: obtain an indication of an upper limit interference level, at the first AP, from uplink transmissions from the second client device, where the indication of the upper limit interference level indicates that the second AP is able to share the TXOP with the first AP if the second AP configures an uplink transmit power that is associated with an interference level, at the first AP, that is less than or equal to the upper limit interference level, and where the interference level at the first AP is associated with the link measurements obtained from the second client device.

Clause 28: The apparatus of clause 27, where the one or more interfaces are further configured to: output a frame that indicates an upper limit transmit power for the second client device in accordance with the upper limit interference level, where the uplink transmit power is less than or equal to the upper limit transmit power, and where the frame includes a control frame or a management frame.

Clause 29: The apparatus of any of clauses 22 through 28, where the one or more interfaces are further configured to: obtain one or more frames from one or more client devices of the first AP, where the interference measurement is associated with a strongest receive power, at the second AP, of the one or more frames obtained from the one or more client devices of the first AP.

Clause 30: The apparatus of clause 29, where, to obtain the information associated with the conditional sharing of the TXOP by the second AP, the one or more interfaces are configured to: obtain a message including an indication of a transmit power of the first AP, an indication of a target SIR between the first AP and the first client device, and an indication of a receive power of a frame, of the one or more frames, at the first AP, where an upper limit transmit power of the second AP is associated with the transmit power of the first AP, the target SIR, the receive power at the first AP, and the strongest receive power at the second AP, and where the message indicates that the second AP is able to share the TXOP with the first AP if the second AP uses a transmit power that is less than or equal to the upper limit transmit power.

Clause 31: The apparatus of clause 30, where the one or more interfaces are further configured to: output, to the second client device, a Trigger frame that triggers an uplink transmission or a peer-to-peer transmission from the second client device and that indicates the transmit power that is less than or equal to the upper limit transmit power.

Clause 32: The apparatus of any of clauses 22 through 31, where the one or more interfaces are further configured to: output, to one or more client devices of the second AP, a frame that triggers one or more response frames from the one or more client devices of the second AP.

Clause 33: The apparatus of clause 32, where the one or more interfaces are further configured to: obtain, from the first AP, a second frame that triggers the interference measurement, where outputting the frame that triggers the one or more response frames is associated with obtaining the second frame that triggers the interference measurement.

Clause 34: The apparatus of any of clauses 32 through 33, where, to obtain the information associated with the conditional sharing of the TXOP by the second AP, the one or more interfaces are configured to: obtain an indication of an uplink power backoff, where the uplink power backoff is associated with the one or more frames, and where the indication of the uplink power backoff indicates that the second AP is able to share the TXOP with the first AP if the second AP uses the uplink power backoff for uplink transmissions to the second AP.

Clause 35: The apparatus of any of clauses 22 through 34, where, to obtain the indication of the TXOP for the first AP and the information associated with the conditional sharing of the TXOP by the second AP, the one or more interfaces are configured to: obtain an indication of allocation information associated with the TXOP, where the allocation information indicates a respective time domain resource allocation, within the TXOP, for communication by a respective AP of a set of APs with which the TXOP is conditionally shared, where the set of APs with which the TXOP is conditionally shared includes the second AP.

Clause 36: The apparatus of any of clauses 22 through 35, where the one or more interfaces are further configured to: obtain, from the first AP, a request for a buffer status of the second AP, a QoS associated with the second AP, or a target transmit power of the second AP, where obtaining the indication of the TXOP for the first AP and the information associated with the conditional sharing of the TXOP by the second AP is associated with the buffer status of the second AP, the QoS associated with the second AP, or the target transmit power of the second AP.

Clause 37: The apparatus of any of clauses 22 through 36, where, to obtain the indication of the TXOP for the first AP, the one or more interfaces are configured to: obtain a frame that allocates the conditional sharing of the TXOP with the second AP, where the frame includes one or both of an indication of a communication schedule between the first AP and the first client device or padding, and where the communication schedule or the padding are associated with enabling a use of the TXOP at the second AP.

Clause 38: The apparatus of clause 37, where the one or more interfaces are further configured to: output, to the first AP, an indication of a minimum transmit power associated with the second communication link between the second AP and the second client device, where obtaining the frame that allocates the conditional sharing of the TXOP is associated with the indication of the minimum transmit power.

Clause 39: The apparatus of any of clauses 22 through 38, where the message includes a control frame, the first AP and the second AP communicate using different frequency channels in accordance with a reuse factor associated with the first AP and the second AP, and the first AP and the second AP share the TXOP during a TXOP associated with the control frame in accordance with the first AP and the second AP using the different frequency channels.

Clause 40: The apparatus of any of clauses 22 through 39, where the information associated with the conditional sharing of the TXOP by the second AP includes an indication that the second AP is able to share the TXOP in accordance with an alignment between first transmissions associated with the first communication link and second transmissions associated with the second communication link, and the alignment includes a start time alignment or a staggered start time alignment.

Clause 41: The apparatus of any of clauses 22 through 40, where the information associated with the conditional sharing of the TXOP by the second AP indicates a time domain resource allocation, within the TXOP, for the second AP and indicates an interference constraint or a transmit power constraint, or both, for the second AP to satisfy to be able to output or obtain during the time domain resource allocation.

Clause 42: The apparatus of any of clauses 22 through 41, where the message includes a downlink data message, or includes a frame that triggers an uplink data message from the second client device.

Clause 43: The apparatus of any of clauses 22 through 42, where, in addition to having one or more interfaces, the apparatus for wireless communication at the second AP can include a processing system capable of (or configured to) to implement the innovative features of the disclosure.

Clause 44: A method for wireless communication at a first AP, including: transmitting, to a second AP, an indication of a TXOP for the first AP and information associated with a conditional sharing of the TXOP by the second AP, where the information is associated with an interference measurement between a first communication link and a second communication link, where the first communication link is between the first AP and a first client device of the first AP and the second communication link is between the second AP and a second client device of the second AP; and transmitting, to the first client device, a message during the TXOP.

Clause 45: The method of clause 44, further including: receiving, from the second AP, an indication of a schedule of measurement packets from the second AP; and transmitting, to the first client device, an indication of one or more transmissions times of the measurement packets from the second AP, where the one or more transmission times are associated with the schedule, and where the interference measurement is associated with the measurement packets from the second AP.

Clause 46: The method of clause 45, further including: transmitting, to the first client device, a frame requesting link measurements associated with the measurement packets from the second AP; and receiving, from the first client device, the link measurements associated with the measurement packets from the second AP, where the interference measurement is associated with the link measurements.

Clause 47: The method of clause 46, where transmitting the information associated with the conditional sharing of the TXOP by the second AP includes: transmitting an indication of an upper limit transmit power of the second AP in accordance with the link measurements received from the first client device, where the indication of the upper limit transmit power indicates that the second AP is able to share the TXOP with the first AP if the second AP uses a transmit power that is less than or equal to the upper limit transmit power.

Clause 48: The method of any of clauses 45 through 47, where the schedule of the measurement packets from the second AP are associated with a transmit power, and the first AP receives an indication of the transmit power from the second AP or the measurement packets indicate the transmit power.

Clause 49: The method of any of clauses 44 through 48, further including: transmitting, to the second AP, an indication of a schedule of measurement packets from the first AP; and transmitting the measurement packets in accordance with the schedule.

Clause 50: The method of clause 49, where transmitting the information associated with the conditional sharing of the TXOP by the second AP includes: transmitting an indication of an upper limit interference level, at the first AP, from uplink transmissions from the second client device, where the indication of the upper limit interference level indicates that the second AP is able to share the TXOP with the first AP if the second AP configures an uplink transmit power that is associated with an interference level, at the first AP, that is less than or equal to the upper limit interference level.

Clause 51: The method of any of clauses 44 through 50, further including: transmitting, to the first client device, a frame that triggers a response frame from the first client device.

Clause 52: The method of clause 51, where transmitting the information associated with the conditional sharing of the TXOP by the second AP includes: transmitting a message including an indication of a transmit power of the first AP, an indication of a target SIR between the first AP and the first client device, and an indication of a first receive power of the response frame at the first AP, where an upper limit transmit power of the second AP is associated with the transmit power of the first AP, the target SIR, the first receive power of the response frame at the first AP, and a second receive power of the response frame at the second AP, and where the message indicates that the second AP is able to share the TXOP with the first AP if the second AP uses a transmit power that is less than or equal to the upper limit transmit power.

Clause 53: The method of any of clauses 44 through 52, further including: receiving one or more frames from one or more client devices of the second AP, where the interference measurement is associated with a strongest receive power, at the first AP, of the one or more frames received from the one or more client devices of the second AP.

Clause 54: The method of clause 53, further including: transmitting, to the second AP, a frame that triggers the interference measurement, where receiving the one or more frames from the one or more client devices of the second AP is associated with transmitting the frame that triggers the interference measurement.

Clause 55: The method of any of clauses 53 through 54, where transmitting the information associated with the conditional sharing of the TXOP by the second AP includes: transmitting an indication of an uplink power backoff associated with the strongest receive power of the one or more frames, where the indication of the uplink power backoff indicates that the second AP is able to share the TXOP with the first AP if the second AP uses the uplink power backoff for uplink transmissions to the second AP.

Clause 56: The method of any of clauses 44 through 55, where transmitting the indication of the TXOP for the first AP and the information associated with the conditional sharing of the TXOP by the second AP includes: transmitting an indication of allocation information associated with the TXOP, where the allocation information indicates a respective time domain resource allocation, within the TXOP, for communication by a respective AP of a set of APs with which the TXOP is conditionally shared, where the set of APs with which the TXOP is conditionally shared includes the second AP.

Clause 57: The method of any of clauses 44 through 56, further including: transmitting, to the second AP, a request for a buffer status of the second AP, a QoS associated with the second AP, or a target transmit power of the second AP, where transmitting the indication of the TXOP for the first AP and the information associated with the conditional sharing of the TXOP by the second AP is associated with the buffer status of the second AP, the QoS associated with the second AP, or the target transmit power of the second AP.

Clause 58: The method of any of clauses 44 through 57, where transmitting the indication of the TXOP for the first AP includes: transmitting a frame that allocates the conditional sharing of the TXOP with the second AP, where the frame includes one or both of an indication of a communication schedule between the first AP and the first client device or padding, and where the communication schedule or the padding are associated with facilitating use of the TXOP at the second AP.

Clause 59: The method of clause 58, further including: receiving, from the second AP, an indication that the second AP is unable to share the TXOP in accordance with the information associated with the conditional sharing of the TXOP.

Clause 60: The method of any of clauses 44 through 59, where the message includes a control frame, the first AP and the second AP communicate using different frequency channels in accordance with a reuse factor associated with the first AP and the second AP, and the first AP and the second AP share the TXOP during a TXOP associated with the control frame in accordance with the first AP and the second AP using the different frequency channels.

Clause 61: The method of any of clauses 44 through 60, where the information associated with the conditional sharing of the TXOP by the second AP includes an indication that the second AP is able to share the TXOP in accordance with an alignment between first transmissions associated with the first communication link and second transmissions associated with the second communication link, and the alignment includes a start time alignment or a staggered start time alignment.

Clause 62: The method of any of clauses 44 through 61, where the information associated with the conditional sharing of the TXOP by the second AP indicates a time domain resource allocation, within the TXOP, for the second AP and indicates an interference constraint or a transmit power constraint, or both, for the second AP to satisfy to be able to transmit or receive during the time domain resource allocation.

Clause 63: The method of any of clauses 44 through 62, where the message includes a downlink data message, or includes a frame that triggers an uplink data message from the first client device.

Clause 64: A method for wireless communication, including: receiving, from a first AP at a second AP, an indication of a TXOP for the first AP and information associated with a conditional sharing of the TXOP by the second AP, where the information is associated with an interference measurement between a first communication link and a second communication link, where the first communication link is between the first AP and a first client device of the first AP and the second communication link is between the second AP and a second client device of the second AP; and transmitting, to the second client device, a message during the TXOP.

Clause 65: The method of clause 64, further including: transmitting, to the first AP, an indication of a schedule of measurement packets from the second AP, where the interference measurement is associated with the measurement packets from the second AP.

Clause 66: The method of clause 65, where receiving the information associated with the conditional sharing of the TXOP by the second AP includes: receiving an indication of an upper limit transmit power of the second AP, where the upper limit transmit power is associated with link measurements of the measurement packets from the second AP, and where the indication of the upper limit transmit power indicates that the second AP is able to share the TXOP with the first AP if the second AP uses a transmit power that is less than or equal to the upper limit transmit power.

Clause 67: The method of any of clauses 64 through 66, further including: receiving, from the first AP, an indication of a schedule of measurement packets from the first AP; and transmitting, to the second client device, an indication of one or more transmissions times of the measurement packets from the first AP, where the one or more transmission times are associated with the schedule, and where the interference measurement is associated with the measurement packets from the first AP.

Clause 68: The method of clause 67, further including: transmitting, to the second client device, a frame requesting link measurements associated with the measurement packets from the first AP; and receiving, from the second client device, the link measurements associated with the measurement packets from the first AP, where the interference measurement is associated with the link measurements.

Clause 69: The method of clause 68, where receiving the information associated with the conditional sharing of the TXOP by the second AP includes: receiving an indication of an upper limit interference level, at the first AP, from uplink transmissions from the second client device, where the indication of the upper limit interference level indicates that the second AP is able to share the TXOP with the first AP if the second AP configures an uplink transmit power that is associated with an interference level, at the first AP, that is less than or equal to the upper limit interference level, and where the interference level at the first AP is associated with the link measurements received from the second client device.

Clause 70: The method of clause 69, where transmitting the message includes: transmitting a control frame that indicates an upper limit transmit power for the second client device in accordance with the upper limit interference level, where the uplink transmit power is less than or equal to the upper limit transmit power.

Clause 71: The method of any of clauses 64 through 70, further including: receiving one or more frames from one or more client devices of the first AP, where the interference measurement is associated with a strongest receive power, at the second AP, of the one or more frames received from the one or more client devices of the first AP.

Clause 72: The method of clause 71, where receiving the information associated with the conditional sharing of the TXOP by the second AP includes: receiving a message including an indication of a transmit power of the first AP, an indication of a target SIR between the first AP and the first client device, and an indication of a receive power of a frame, of the one or more frames, at the first AP, where an upper limit transmit power of the second AP is associated with the transmit power of the first AP, the target SIR, the receive power at the first AP, and the strongest receive power at the second AP, and where the message indicates that the second AP is able to share the TXOP with the first AP if the second AP uses a transmit power that is less than or equal to the upper limit transmit power.

Clause 73: The method of clause 72, further including: transmitting, to the second client device, a Trigger frame that triggers an uplink transmission or a peer-to-peer transmission from the second client device and that indicates the transmit power that is less than or equal to the upper limit transmit power.

Clause 74: The method of any of clauses 64 through 73, further including: transmitting, to one or more client devices of the second AP, a frame that triggers one or more response frames from the one or more client devices of the second AP.

Clause 75: The method of clause 74, further including: receiving, from the first AP, a second frame that triggers the interference measurement, where transmitting the frame that triggers the one or more response frames is associated with receiving the second frame that triggers the interference measurement.

Clause 76: The method of any of clauses 74 through 75, where receiving the information associated with the conditional sharing of the TXOP by the second AP includes: receiving an indication of an uplink power backoff, where the uplink power backoff is associated with the one or more frames, and where the indication of the uplink power backoff indicates that the second AP is able to share the TXOP with the first AP if the second AP uses the uplink power backoff for uplink transmissions to the second AP.

Clause 77: The method of any of clauses 64 through 76, where receiving the indication of the TXOP for the first AP and the information associated with the conditional sharing of the TXOP by the second AP includes: receiving an indication of allocation information associated with the TXOP, where the allocation information indicates a respective time domain resource allocation, within the TXOP, for communication by a respective AP of a set of APs with which the TXOP is conditionally shared, where the set of APs with which the TXOP is conditionally shared includes the second AP.

Clause 78: The method of any of clauses 64 through 77, further including: receiving, from the first AP, a request for a buffer status of the second AP, a QoS associated with the second AP, or a target transmit power of the second AP, where receiving the indication of the TXOP for the first AP and the information associated with the conditional sharing of the TXOP by the second AP is associated with the buffer status of the second AP, the QoS associated with the second AP, or the target transmit power of the second AP.

Clause 79: The method of any of clauses 64 through 78, where receiving the indication of the TXOP for the first AP includes: receiving a frame that allocates the conditional sharing of the TXOP with the second AP, where the frame includes one or both of an indication of a communication schedule between the first AP and the first client device or padding, and where the communication schedule or the padding are associated with enabling a use of the TXOP at the second AP.

Clause 80: The method of clause 79, further including: transmitting, to the first AP, an indication of a minimum transmit power associated with the second communication link between the second AP and the second client device, where receiving the frame that allocates the conditional sharing of the TXOP is associated with the indication of the minimum transmit power.

Clause 81: The method of any of clauses 64 through 80, where the message includes a control frame, the first AP and the second AP communicate using different frequency channels in accordance with a reuse factor associated with the first AP and the second AP, and the first AP and the second AP share the TXOP during a TXOP associated with the control frame in accordance with the first AP and the second AP using the different frequency channels.

Clause 82: The method of any of clauses 64 through 81, where the information associated with the conditional sharing of the TXOP by the second AP includes an indication that the second AP is able to share the TXOP in accordance with an alignment between first transmissions associated with the first communication link and second transmissions associated with the second communication link, and the alignment includes a start time alignment or a staggered start time alignment.

Clause 83: The method of any of clauses 64 through 82, where the information associated with the conditional sharing of the TXOP by the second AP indicates a time domain resource allocation, within the TXOP, for the second AP and indicates an interference constraint or a transmit power constraint, or both, for the second AP to satisfy to be able to transmit or receive during the time domain resource allocation.

Clause 84: The method of any of clauses 64 through 83, where the message includes a downlink data message, or includes a frame that triggers an uplink data message from the second client device.

Clause 85: The method of any of clauses 64 through 84, further including: acquiring the TXOP from the first AP in accordance with receiving the indication of the TXOP; and transmitting, to a third AP in accordance with acquiring the TXOP from the first AP, an indication of the TXOP and second information associated with a second conditional sharing of the TXOP by the third AP.

Clause 86: The method of any of clauses 64 through 85, where a first BSS bandwidth of the first AP and a second BSS bandwidth of the second AP at least partially overlap, and the second AP receives the information associated with the conditional sharing of the TXOP by the second AP via an overlapping portion of the first BSS bandwidth and the second BSS bandwidth.

Clause 87: The method of any of clauses 64 through 86, further including: receiving, from the first AP, a frame associated with an overlapping TWT of the first AP and the second AP, where the frame indicates a set of C-SR parameters associated with the overlapping TWT, and where the set of C-SR parameters indicated by the frame are associated with the interference measurement.

Clause 88: An apparatus for wireless communication at a first AP, including at least one means for transmitting, to a second AP, an indication of a TXOP for the first AP and information associated with a conditional sharing of the TXOP by the second AP, where the information is associated with an interference measurement between a first communication link and a second communication link, where the first communication link is between the first AP and a first client device of the first AP and the second communication link is between the second AP and a second client device of the second AP; and means for transmitting, to the first client device, a message during the TXOP.

Clause 89: A non-transitory computer-readable medium storing code for wireless communication at a first AP, the code including instructions executable by a processor to transmit, to a second AP, an indication of a TXOP for the first AP and information associated with a conditional sharing of the TXOP by the second AP, where the information is associated with an interference measurement between a first communication link and a second communication link, where the first communication link is between the first AP and a first client device of the first AP and the second communication link is between the second AP and a second client device of the second AP; and transmit, to the first client device, a message during the TXOP

Clause 90: An apparatus for wireless communication, including at least one means for receiving, from a first AP at a second AP, an indication of a TXOP for the first AP and information associated with a conditional sharing of the TXOP by the second AP, where the information is associated with an interference measurement between a first communication link and a second communication link, where the first communication link is between the first AP and a first client device of the first AP and the second communication link is between the second AP and a second client device of the second AP; and means for transmitting, to the second client device, a message during the TXOP.

Clause 91: A non-transitory computer-readable medium storing code for wireless communication, the code including instructions executable by a processor to receive, from a first AP at a second AP, an indication of a TXOP for the first AP and information associated with a conditional sharing of the TXOP by the second AP, where the information is associated with an interference measurement between a first communication link and a second communication link, where the first communication link is between the first AP and a first client device of the first AP and the second communication link is between the second AP and a second client device of the second AP; and transmit, to the second client device, a message during the TXOP.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,”’ or the equivalent in context, whatever it is that is “based on ‘a,’” or “based at least in part on ‘a,”’ may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some implementations be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

Please enter the following amendments to the claims:

1. An apparatus for wireless communication at a first access point (AP), comprising:
one or more interfaces configured to:
output, to a second AP, an indication of a transmission opportunity (TXOP) for the first AP and information associated with a conditional sharing of the TXOP by the second AP, wherein the information is associated with an interference measurement between a first communication link and a second communication link, wherein the first communication link is between the first AP and a first client device of the first AP and the second communication link is between the second AP and a second client device of the second AP; and
output, to the first client device, a message during the TXOP.

2. The apparatus of claim 1, wherein the one or more interfaces are further configured to:
obtain, from the second AP, an indication of a schedule of measurement packets from the second AP; and
output, to the first client device, an indication of one or more transmissions times of the measurement packets from the second AP, wherein the one or more transmission times are associated with the schedule, and wherein the interference measurement is associated with the measurement packets from the second AP.

3. The apparatus of claim 2, wherein the one or more interfaces are further configured to:
output, to the first client device, a frame requesting link measurements associated with the measurement packets from the second AP; and
obtain, from the first client device, the link measurements associated with the measurement packets from the second AP, wherein the interference measurement is associated with the link measurements.

4. The apparatus of claim 3, wherein, to output the information associated with the conditional sharing of the TXOP by the second AP, the one or more interfaces are configured to:
output an indication of an upper limit transmit power of the second AP in accordance with the link measurements obtained from the first client device, wherein the indication of the upper limit transmit power indicates that the second AP is able to share the TXOP with the first AP if the second AP uses a transmit power that is less than or equal to the upper limit transmit power.

5-7. (canceled)

8. The apparatus of claim 1, wherein the one or more interfaces are further configured to:
output, to the first client device, a frame that triggers a response frame from the first client device.

9. The apparatus of claim 8, wherein, to output the information associated with the conditional sharing of the TXOP by the second AP, the one or more interfaces are configured to:
output a message including an indication of a transmit power of the first AP, an indication of a target signal-to-interference ratio (SIR) between the first AP and the first client device, and an indication of a first receive power of the response frame at the first AP, wherein an upper limit transmit power of the second AP is associated with the transmit power of the first AP, the target SIR, the first receive power of the response frame at the first AP, and a second receive power of the response frame at the second AP, and wherein the message indicates that the second AP is able to share the TXOP with the first AP if the second AP uses a transmit power that is less than or equal to the upper limit transmit power.

10-12. (canceled)

13. The apparatus of claim 1, wherein, to output the indication of the TXOP for the first AP and the information associated with the conditional sharing of the TXOP by the second AP, the one or more interfaces are configured to:
output an indication of allocation information associated with the TXOP, wherein the allocation information indicates a respective time domain resource allocation, within the TXOP, for communication by a respective AP of a set of APs with which the TXOP is conditionally shared, wherein the set of APs with which the TXOP is conditionally shared includes the second AP.

14. The apparatus of claim 1, wherein the one or more interfaces are further configured to:
output, to the second AP, a request for a buffer status of the second AP, a quality of service (QoS) associated with the second AP, or a target transmit power of the second AP, wherein outputting the indication of the TXOP for the first AP and the information associated with the conditional sharing of the TXOP by the second AP is associated with the buffer status of the second AP, the QoS associated with the second AP, or the target transmit power of the second AP.

15. The apparatus of claim 1, wherein, to output the indication of the TXOP for the first AP, the one or more interfaces are configured to:
output a frame that allocates the conditional sharing of the TXOP with the second AP, wherein the frame includes one or both of an indication of a communication schedule between the first AP and the first client device or padding, and wherein the communication schedule or the padding are associated with facilitating use of the TXOP at the second AP.

16. The apparatus of claim 15, wherein the one or more interfaces are further configured to:
obtain, from the second AP, an indication that the second AP is unable to share the TXOP in accordance with the information associated with the conditional sharing of the TXOP.

17-20. (canceled)

21. An apparatus for wireless communication, comprising:
one or more interfaces configured to:
obtain, from a first access point (AP) at a second AP, an indication of a transmission opportunity (TXOP) for the first AP and information associated with a conditional sharing of the TXOP by the second AP, wherein the information is associated with an interference measurement between a first communication link and a second communication link, wherein the first communication link is between the first AP and a first client device of the first AP and the second communication link is between the second AP and a second client device of the second AP; and
output, to the second client device, a message during the TXOP.

22. (canceled)

23. (canceled)

24. The apparatus of claim 21, wherein the one or more interfaces are further configured to:
obtain, from the first AP, an indication of a schedule of measurement packets from the first AP; and
output, to the second client device, an indication of one or more transmissions times of the measurement packets from the first AP, wherein the one or more transmission times are associated with the schedule, and wherein the interference measurement is associated with the measurement packets from the first AP.

25. The apparatus of claim 24, wherein the one or more interfaces are further configured to:
output, to the second client device, a frame requesting link measurements associated with the measurement packets from the first AP; and
obtain, from the second client device, the link measurements associated with the measurement packets from the first AP, wherein the interference measurement is associated with the link measurements.

26. The apparatus of claim 25, wherein, to obtain the information associated with the conditional sharing of the TXOP by the second AP, the one or more interfaces are configured to:
obtain an indication of an upper limit interference level, at the first AP, from uplink transmissions from the second client device, wherein the indication of the upper limit interference level indicates that the second AP is able to share the TXOP with the first AP if the second AP configures an uplink transmit power that is associated with an interference level, at the first AP, that is less than or equal to the upper limit interference level, and wherein the interference level at the first AP is associated with the link measurements obtained from the second client device.

27. The apparatus of claim 26, wherein the one or more interfaces are further configured to:
output a frame that indicates an upper limit transmit power for the second client device in accordance with the upper limit interference level, wherein the uplink transmit power is less than or equal to the upper limit transmit power, and wherein the frame includes a control frame or a management frame.

28. The apparatus of claim 21, wherein the one or more interfaces are further configured to:
obtain one or more frames from one or more client devices of the first AP, wherein the interference measurement is associated with a strongest receive power, at the second AP, of the one or more frames obtained from the one or more client devices of the first AP.

29. The apparatus of claim 28, wherein, to obtain the information associated with the conditional sharing of the TXOP by the second AP, the one or more interfaces are configured to:
obtain a message including an indication of a transmit power of the first AP, an indication of a target signal-to-interference ratio (SIR) between the first AP and the first client device, and an indication of a receive power of a frame, of the one or more frames, at the first AP, wherein an upper limit transmit power of the second AP is associated with the transmit power of the first AP, the target SIR, the receive power at the first AP, and the strongest receive power at the second AP, and wherein the message indicates that the second AP is able to share the TXOP with the first AP if the second AP uses a transmit power that is less than or equal to the upper limit transmit power.

30. The apparatus of claim 29, wherein the one or more interfaces are further configured to:
output, to the second client device, a Trigger frame that triggers an uplink transmission or a peer-to-peer transmission from the second client device and that indicates the transmit power that is less than or equal to the upper limit transmit power.

31. The apparatus of claim 21, wherein the one or more interfaces are further configured to:
output, to one or more client devices of the second AP, a frame that triggers one or more response frames from the one or more client devices of the second AP.

32. The apparatus of claim 31, wherein the one or more interfaces are further configured to:
obtain, from the first AP, a second frame that triggers the interference measurement, wherein outputting the frame that triggers the one or more response frames is associated with obtaining the second frame that triggers the interference measurement.

33. The apparatus of claim 31, wherein, to obtain the information associated with the conditional sharing of the TXOP by the second AP, the one or more interfaces are configured to:
obtain an indication of an uplink power backoff, wherein the uplink power backoff is associated with the one or more frames, and wherein the indication of the uplink power backoff indicates that the second AP is able to share the TXOP with the first AP if the second AP uses the uplink power backoff for uplink transmissions to the second AP.

34-41. (canceled)

42. A method for wireless communication at a first access point (AP), comprising:
transmitting, to a second AP, an indication of a transmission opportunity (TXOP) for the first AP and information associated with a conditional sharing of the TXOP by the second AP, wherein the information is associated with an interference measurement between a first communication link and a second communication link, wherein the first communication link is between the first AP and a first client device of the first AP and the second communication link is between the second AP and a second client device of the second AP; and
transmitting, to the first client device, a message during the TXOP.

43-46. (canceled)

47. The method of claim 42, further comprising:
transmitting, to the second AP, an indication of a schedule of measurement packets from the first AP; and
transmitting the measurement packets in accordance with the schedule.

48. The method of claim 47, wherein transmitting the information associated with the conditional sharing of the TXOP by the second AP comprises:
transmitting an indication of an upper limit interference level, at the first AP, from uplink transmissions from the second client device, wherein the indication of the upper limit interference level indicates that the second AP is able to share the TXOP with the first AP if the second AP configures an uplink transmit power that is associated with an interference level, at the first AP, that is less than or equal to the upper limit interference level.

49. (canceled)

50. (canceled)

51. The method of claim 42, further comprising:
receiving one or more frames from one or more client devices of the second AP, wherein the interference measurement is associated with a strongest receive power, at the first AP, of the one or more frames received from the one or more client devices of the second AP.

52. (canceled)

53. The method of claim 51, wherein transmitting the information associated with the conditional sharing of the TXOP by the second AP comprises:
transmitting an indication of an uplink power backoff associated with the strongest receive power of the one or more frames, wherein the indication of the uplink power backoff indicates that the second AP is able to share the TXOP with the first AP if the second AP uses the uplink power backoff for uplink transmissions to the second AP.

54-61. (canceled)

62. A method for wireless communication, comprising:
receiving, from a first access point (AP) at a second AP, an indication of a transmission opportunity (TXOP) for the first AP and information associated with a conditional sharing of the TXOP by the second AP, wherein the information is associated with an interference measurement between a first communication link and a second communication link, wherein the first communication link is between the first AP and a first client device of the first AP and the second communication link is between the second AP and a second client device of the second AP; and
transmitting, to the second client device, a message during the TXOP.

63-82. (canceled)

83. The method of claim 62, further comprising:
acquiring the TXOP from the first AP in accordance with receiving the indication of the TXOP; and
transmitting, to a third AP in accordance with acquiring the TXOP from the first AP, an indication of the TXOP and second information associated with a second conditional sharing of the TXOP by the third AP.

84. The method of claim 62, wherein a first basic service set (BSS) bandwidth of the first AP and a second BSS bandwidth of the second AP at least partially overlap, and wherein the second AP receives the information associated with the conditional sharing of the TXOP by the second AP via an overlapping portion of the first BSS bandwidth and the second BSS bandwidth.

85. The method of claim 62, further comprising:
receiving, from the first AP, a frame associated with an overlapping target wake time (TWT) of the first AP and the second AP, wherein the frame indicates a set of coordinated spatial reuse (C-SR) parameters associated with the overlapping TWT, and wherein the set of C-SR parameters indicated by the frame are associated with the interference measurement.
